(19) United States
(12) Patent Application Publication
(10) Pub. No.: US 2016/0182135 A1
(43) Pub. Date: Jun. 23, 2016

(54) FEEDBACK INFORMATION NOTIFICATION METHOD, TERMINAL DEVICE, BASE STATION DEVICE, RADIO COMMUNICATION SYSTEM, AND INTEGRATED CIRCUIT

(71) Applicant: SHARP KABUSHIKI KAISHA, Osaka-shi, Osaka (JP)

(72) Inventors: Takashi ONODERA, Osaka-shi (JP); Hiromichi TOMEBA, Osaka-shi (JP); Minoru KUBOTA, Osaka-shi (JP)

(73) Assignee: Sharp Kabushiki Kaisha, Osaka-shi, Osaka (JP)

(21) Appl. No.: 14/773,835

(22) PCT Filed: Feb. 6, 2014
(86) PCT No.: PCT/JP2014/052760

§ 371 Date: Sep. 9, 2015

(30) Foreign Application Priority Data
Mar. 13, 2013 (JP) 2013-049800

(51) Int. Cl. H04B 7/04; H04L 5/00; H04W 72/04

(52) U.S. Cl. CPC H04B 7/0478; H04B 7/0452; H04B 7/0417; H04W 72/0413; H04L 5/0057

(57) ABSTRACT

A feedback information notification method of the present invention notifies of channel quality information indicating a channel quality during multi-user MIMO transmission at a first feedback timing, and differential channel quality information based on a difference value between a channel quality during the multi-user MIMO transmission and a channel quality indicated by the channel quality information of which notification is most recently sent, at a second feedback timing.

### TECHNICAL FIELD

The present invention relates to a feedback information notification method, a terminal device, a base station device, a radio communication system, and an integrated circuit.

### BACKGROUND ART

A multiple-input multiple-output (MIMO) transmission technique for spatially multiplexing and simultaneously communicating a plurality of different data sequences (data streams) in the same frequency band by using a plurality of antennas for transmission and reception has been practically used in a wireless LAN, a cellular system, or the like. In a single user MIMO (SU-MIMO) that spatially multiplexes a plurality of different data sequences and transmits them to a certain terminal device (reception device, user equipment (UE)), there is a method in which a base station device (transmission device, eNodeB, access point) transmits a transmit signal subjected to pre-coding, in order to improve a separation and detection performance of a plurality of data sequences in a terminal device.

Further, in a cellular system such as long term evolution (LTE) and LTE-Advanced (LTE-A) which are standardized by Third Generation Partnership Project (3GPP), and a wireless LAN system such as IEEE802.11ac that is standardized by The Institute of Electrical and Electronics Engineers, Inc. (IEEE), a system has been proposed in which the number of transmission antennas provided in the base station device (access point) is significantly larger than the number of reception antennas provided in the terminal device, and a multi-user MIMO (MU-MIMO) has been proposed which MIMO-multiplexes data sequences addressed to a plurality of terminal devices (users) in order to improve the system throughput by effectively using a number of transmission antennas of the base station device.

In the MU-MIMO, since a transmit signal addressed to another terminal device is input to the terminal device as inter-user-interference (IUI), it is necessary to suppress the IUI. Some methods have been proposed in which if a base station device knows a state (channel state) of a channel from respective transmission antennas of the base station device to respective reception antennas of respective terminal devices, the base station device can generate a transmit signal capable of suppressing IUI generated during the reception by the terminal device, without imposing a large load on the terminal device (NPL 1).

However, in a radio communication system based on frequency division duplex (FDD) using different carrier frequencies in uplink and downlink, there is a problem that channel state information (CSI) indicating a channel state needs to be fed back from the terminal device and thus overhead significantly increases in order for the base station device to obtain a state of a channel from each transmission antenna of the base station device to each reception antenna of each terminal devices, in downlink.

Therefore, in LTE, a closed-loop type MIMO transmission scheme using a codebook, which is capable of significantly suppressing the amount of overhead required for notification of CSI, is supported. In the closed-loop type MIMO using a codebook, a base station device and a terminal device share in advance a codebook storing a plurality of pre-coding matrices (linear filters) described therein, and the terminal device extracts a desired pre-coding matrix from the above-described codebook, based on a channel state, and notifies the base station device of the number (precoding matrix indicator: PMI). The base station device performs MIMO transmission after performing pre-coding on transmission data, based on the notified pre-coding matrix. Since CSI is notified based on the codebook, it is possible to significantly suppress the amount of overhead, as compared to a method in which a terminal device notifies of CSI indicating a channel state such as complex channel gains.

However, even in the codebook-based closed-loop type MIMO transmission, there is a problem that if the number of transmission antennas of the base station device increases, the scale of the codebook increases and the amount of overhead increases.

Therefore, in LTE-A, a feedback method is employed in which when a base station device performs MIMO transmission by using eight transmission antennas, the base station device performs pre-coding by using a linear filter obtained by combining two pre-coding matrices (W₁, W₂) which are respectively selected from two types of codebooks: a first codebook based on long-term channel characteristics such as channel correlation and a second codebook based on short-term channel characteristics, and the terminal device notifies the base station device of the number (PMI) of each pre-coding matrix which is selected from each codebook, such that the time average overhead amount can be suppressed (NPL 2, NPL 3).

### CITATION LIST

### Non Patent Literature

NPL 1: Spencer et al., “An Introduction to the Multi-User MIMO Downlink”, IEEE Communication Magazine, Vol. 42, Issue10, pp. 60-67, October, 2004
NPL 2: 3GPP, “Way Forward on 8Tx Codebook for Re1.10 DL MIMO”, R1-105011, August, 2010
NPL 3: 3GPP, “E-UTRA; Physical Channels and Modulation (Release 10)”, TS36.211 V10.5.0, June, 2012

### SUMMARY OF INVENTION

### Technical Problem

However, in the case of performing a codebook-based MU-MIMO, there is a problem that a base station device cannot obtain a channel quality of MU-MIMO transmission in each terminal device, from a result of selecting a combination of a plurality of terminal devices which are spatially multiplexed in the MU-MIMO transmission, only from the PMI which is fed back from the terminal device, and effective MU-MIMO transmission using, for example, adaptive modulation or the like cannot be realized.

The present invention has been made in view of the above problems, and an object of the invention is to provide a feedback information notification method, a terminal device, a base station device, a radio communication system, and an integrated circuit, which enable a terminal device to notify a base station device of channel quality information assuming MU-MIMO, while suppressing the amount of feedback information.

### Solution to Problem

In order to achieve the object described above, the present invention devises the following means. That is, a feedback information notification method according to the present invention is a feedback information notification method in which a terminal device notifies a base station device of feedback information for multi-user MIMO transmission, and the method includes selecting a first pre-coding matrix from a first codebook including at least one pre-coding matrix candidate, and notifying of first pre-coding matrix information indicating the selected first pre-coding matrix, and channel quality information indicating a channel quality during multi-user MIMO transmission, at a first feedback timing; and selecting a second pre-coding matrix from a second codebook including at least one pre-coding matrix candidate, and notifying of second pre-coding matrix information indicating the selected second pre-coding matrix, and channel quality information indicating a channel quality during the multi-user MIMO transmission, at a second feedback timing.

A terminal device according to the present invention is a terminal device that performs communication with a base station device provided with a plurality of antennas, and includes a channel estimation unit that estimates a channel state between each antenna of the base station device and at least one antenna of the terminal device; a pre-coding matrix selection unit that selects a first pre-coding matrix from a first codebook including at least one pre-coding matrix candidate based on the estimation result of the channel state, at a first feedback timing, and selects a second pre-coding matrix from a second codebook including at least one pre-coding matrix candidate, based on the estimation result of the channel state and the most recently selected first pre-coding matrix, at a second feedback timing; a channel quality calculation unit that calculates a channel quality during the multi-user MIMO transmission based on the selected first pre-coding matrix and the estimation result of the channel state at the first feedback timing, and calculates the channel quality during the multi-user MIMO transmission based on the most recently selected first pre-coding matrix, the selected second pre-coding matrix, and the estimation result of the channel state, at the second feedback timing; and a feedback information generation unit that generates first pre-coding matrix information indicating the selected first pre-coding matrix and channel quality information indicating the calculated channel quality during the multi-user MIMO transmission, as feedback information, at the first feedback timing, and generates second pre-coding matrix information indicating the selected second pre-coding matrix and channel quality information indicating the calculated channel quality during the multi-user MIMO transmission, at the second feedback timing.

A base station device according to the present invention is a base station device that is provided with a plurality of antennas, and simultaneously transmits transmission data addressed to a plurality of terminal devices by performing pre-coding and spatial-multiplexing on the transmission data, and the base station device includes a feedback information obtaining unit that obtains either one or both of first pre-coding matrix information indicating a first pre-coding matrix which is selected from a first codebook including at least one pre-coding matrix candidate, and second pre-coding matrix information indicating a second pre-coding matrix which is selected from a second codebook including at least one pre-coding matrix candidate, of which notifications are sent from the plurality of terminal devices, obtains either one or both of channel quality information indicating a channel quality during multi-user MIMO transmission, and differential channel quality information based on a difference value from a channel quality indicated by the channel quality information, and calculates a desired pre-coding matrix which is selected by each of the plurality of terminal devices and a channel quality during the multi-user MIMO transmission; and a pre-coding matrix calculation unit that calculates a pre-coding matrix which is used for pre-coding of transmission data addressed to the plurality of terminal devices, based on the calculated desired pre-coding matrix for each terminal device and the calculated channel quality during the multi-user MIMO transmission, and determines a modulation scheme and a coding rate for the transmission data addressed to the plurality of terminal devices.

A radio communication system according to the present invention a radio communication system including a base station device provided with a plurality of antennas, and a plurality of terminal devices, each terminal device selects a first pre-coding matrix from a first codebook including at least one pre-coding matrix candidate, and notifies the base station device of first pre-coding matrix information indicating the selected first pre-coding matrix, and channel quality information indicating a channel quality during multi-user MIMO transmission, at each first feedback timing, and selects a second pre-coding matrix from a second codebook including at least one pre-coding matrix candidate, and notifies the base station device of second pre-coding matrix information indicating the selected second pre-coding matrix, and channel quality information indicating a channel quality during the multi-user MIMO transmission, at each second feedback timing.

An integrated circuit according to the present invention is an integrated circuit that is implemented in a terminal device and causes the terminal device to exert a plurality of functions of estimating a channel state between each antenna of the base station device and at least one antenna of the terminal device; selecting a first pre-coding matrix from a first codebook including at least one pre-coding matrix candidate based on the estimation result of the channel state, at a first feedback timing, and selecting a second pre-coding matrix from a second codebook including at least one pre-coding matrix candidate, based on the estimation result of the channel state and the most recently selected first pre-coding matrix, at a second feedback timing; calculating a channel quality during the multi-user MIMO transmission based on the selected first pre-coding matrix and the estimation result of the channel state at the first feedback timing, and calculating the channel quality during the multi-user MIMO transmission based on the most recently selected first pre-coding matrix, the selected second pre-coding matrix, and the estimation result of the channel state, at the second feedback timing; and generating first pre-coding matrix information indicating the selected first pre-coding matrix and channel quality information indicating the calculated channel quality during the multi-user MIMO transmission, as feedback information, at the first feedback timing, and generating second pre-coding matrix information indicating the selected second pre-coding matrix and channel quality information indicating the calculated channel quality during the multi-user MIMO transmission, at the second feedback timing.

An integrated circuit according to the present invention is an integrated circuit that is implemented in a base station device and causes the base station device to exert a plurality of functions of obtaining either one or both of first pre-coding matrix information indicating a first pre-coding matrix which is selected from a first codebook including at least one pre-coding matrix candidate, and second pre-coding matrix information indicating a second pre-coding matrix which is selected from a second codebook including at least one pre-coding matrix candidate, of which notifications are sent from the plurality of terminal devices, obtaining either one or both of channel quality information indicating a channel quality during multi-user MIMO transmission, and differential channel quality information based on a difference value from a channel quality indicated by the channel quality information, and calculating a desired pre-coding matrix which is selected by each of the plurality of terminal devices and a channel quality during the multi-user MIMO transmission; and calculating a pre-coding matrix which is used for pre-coding of transmission data addressed to the plurality of terminal devices, based on the calculated desired pre-coding matrix for each terminal device and the calculated channel quality during the multi-user MIMO transmission, and determining a modulation scheme and a coding rate for the transmission data addressed to the plurality of terminal devices.

### Advantageous Effects of Invention

A terminal device can notify a base station device of channel quality information assuming MU-MIMO, while suppressing the amount of feedback information.

### BRIEF DESCRIPTION OF DRAWINGS

FIG. 1 is a schematic diagram illustrating a configuration example of a radio communication system of the present invention.

FIG. 2 is a functional block diagram illustrating a configuration example of a base station device 200 of the present invention.

FIG. 3 is a functional block diagram illustrating a configuration example of a terminal device 300 of the present invention.

FIG. 4 is a sequence chart illustrating an example of transmission and reception of feedback information between the base station device 200 and the terminal device 300 according to a first embodiment of the present invention.

FIG. 5 is diagram illustrating an example of CQI for MU-MIMO according to the first embodiment of the present invention.

FIG. 6 is diagram illustrating an example of differential CQI for MU-MIMO according to the first embodiment of the present invention.

FIG. 7 is a diagram illustrating an example of feedback information that is transmitted and received between the base station device 200 and the terminal device 300 according to the first embodiment of the present invention.

FIG. 8 is a sequence chart illustrating an example of transmission and reception of feedback information between the base station device 200 and the terminal device 300 according to a second embodiment of the present invention.

FIG. 9 is diagram illustrating an example of differential CQI for MU-MIMO according to the second embodiment of the present invention.

FIG. 10 is diagram illustrating another example of differential CQI for MU-MIMO according to the second embodiment of the present invention.

FIG. 11 is a diagram illustrating an example of feedback information that is transmitted and received between the base station device 200 and the terminal device 300 according to the second embodiment of the present invention.

FIG. 12 is a sequence chart illustrating an example of transmission and reception of feedback information between the base station device 200 and the terminal device 300 according to a third embodiment of the present invention.

FIG. 13 is a diagram illustrating an example of feedback information that is transmitted and received between the base station device 200 and the terminal device 300 according to the third embodiment of the present invention.

### DESCRIPTION OF EMBODIMENTS

Embodiments of the present invention will be described later with reference to accompanying drawings. Incidentally, the accompanying drawings illustrate specific embodiments and implementation examples in compliance with the principles of the present invention, but the drawings are intended to understand the present invention and are not intended to be used to restrictively interpret the present invention.

### First Embodiment

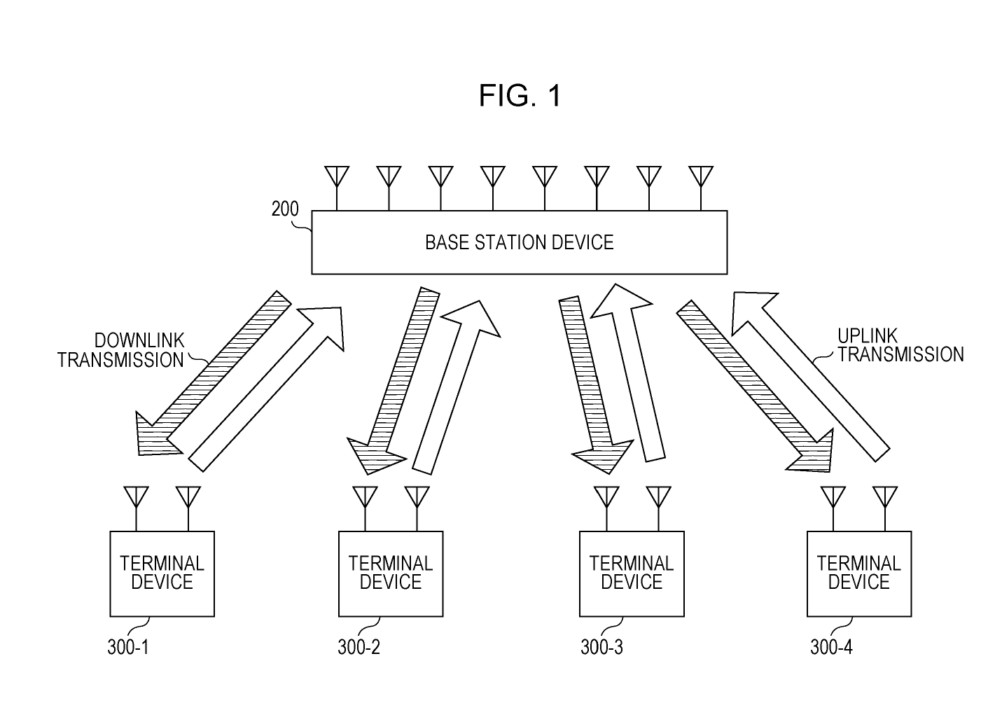

FIG. 1 is a diagram illustrating a schematic configuration example of a radio communication system of the present invention. In an example of a radio communication system in the present embodiment illustrated in FIG. 1, there are a base station device 200, and a plurality of terminal devices 300-1 to 300-4 (these terminal devices are also collectively referred to as a terminal device 300) which are connected to and communicate with the base station device 200.

In the present embodiment, first, the base station device 200 transmits a known reference signal to the plurality of connected terminal devices 300. The terminal device 300 estimates a channel state between respective transmission antennas of the base station device 200 and the reception antenna of the terminal device, based on the received reference signal.

The terminal device 300 selects one desired pre-coding matrix WFB, among a pre-coding matrix W(=W₁W₂) generated by combining two pre-coding matrices W₁ and W₂ which are respectively selected one by one from two types of codebooks: a first codebook (a candidate group for a pre-coding matrix) and a second codebook which are shared between the base station device 200 and the terminal device 300, based on the estimated channel state, at a certain feedback timing (subframe) (hereinafter, referred to as a first feedback timing). In the selection of the desired pre-coding matrix WFB, when the base station device 200 performs pre-coding by using each pre-coding matrix W in the estimated channel state, it is preferable to select a pre-coding matrix W which allows the maximization of a reception signal to interference plus noise power ratio (SINR) or throughput of the terminal device. Further, at the same time, it is preferable to select the number of ranks of MIMO which allows the maximization of throughput.

The terminal device 300 reselects only the second pre-coding matrix W₂, based on the estimation result of the channel state on the same basis, under a condition in which the first pre-coding matrix W₁ selected at the most recent first feedback timing is used as it is, at another feedback timing (hereinafter, referred to as a second feedback timing), and selects a new desired pre-coding matrix WFB. In addition, the first feedback timing and the second feedback timing may occur at different periods or different frequencies. Unless otherwise indicated, in the following, the first feedback timing and the second feedback timing occur at different periods, and when the first feedback timing and the second feedback timing overlap, they are described as the first feedback timing.

Assuming a case where the base station device 200 performs pre-coding using the selected desired pre-coding matrix WFB, and performs MU-MIMO transmission in combination with another terminal device, the terminal device 300 calculates channel (reception) quality (channel quality indicator: CQI) while taking into account the inter-user interference (IUI) in this case, for example, SINR, and generates channel quality information (reception quality information) during MU-MIMO transmission, based on the calculated CQI. Hereinafter, the CQI for the MU-MIMO transmission is referred to as MU-CQI, and the CQI for SU-MIMO transmission in the related art without taking into account the inter-user interference and the like is referred to as SU-CQI.

The terminal device 300 notifies (feedback) the base station device 200 of first pre-coding matrix information PMI₁ and second pre-coding matrix information PMI₂ respectively indicating the numbers (precoding matrix indicator: PMI) of two pre-coding matrix W₁ (hereinafter, referred to as a first pre-coding matrix) and W₂ (hereinafter, referred to as a second pre-coding matrix), both of which generate the selected desired pre-coding matrix W_{FB}, and channel quality information CQI_{MU} which is a number indicating MU-CQI at the first feedback timing, and notifies the base station device 200 of PMI₂ indicating the number of the second pre-coding matrix W₂ which is reselected, and differential channel quality information ΔCQI_{MU} which is the number indicating a difference value between a newly calculated MU-CQI and the MU-CQI which has been notified at the most recent first feedback timing, at the second feedback timing. Further, information regarding the number of ranks of MIMO (rank indicator: RI) may be notified. In addition, the details about the feedback information will be described later.

The base station device 200 obtains feedback information PMI₁, PMI₂ and CQI_{MU}, or PMI₂ and ΔCQI_{MU} which have been notified from each terminal device 300, and performs pre-coding on transmission data addressed to each terminal device 300, based on the information. Further, prior to the pre-coding, it is preferable to perform adaptive modulation for determining modulation parameters such as a modulation and coding scheme (MCS) caused by a combination of a modulation scheme and a coding rate for the transmission data addressed to each terminal device 300, based on the MU-CQI that has been notified from each terminal device 300. The base station device 200 spatially multiplexes the transmission data subjected to the pre-coding into the same radio resource and transmits it.

The terminal device 300 that has received the MU-MIMO signal obtained by spatially multiplexing the transmission data addressed to a plurality of terminal devices 300 detects desired data addressed to the terminal device, based on the estimation result of the channel state described above.

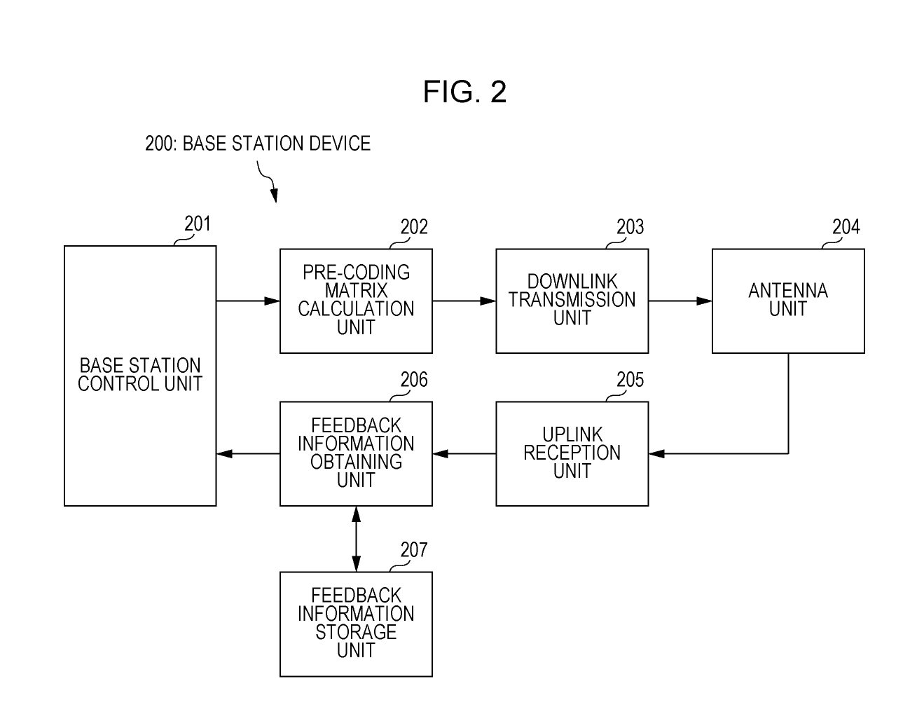

FIG. 2 is a functional block diagram illustrating a configuration example of a base station device 200 of the present invention. In FIG. 2, the base station device 200 is configured with a base station control unit 201, a pre-coding matrix calculation unit 202, a downlink transmission unit 203, an antenna unit 204, an uplink reception unit 205, a feedback information obtaining unit 206, and a feedback information storage unit 207.

The antenna unit 204 includes a plurality of transmission and reception antennas, receives an uplink radio signal and transmits a downlink radio signal.

The uplink reception unit 205 receives an uplink transmit signal that has been transmitted from the terminal device 300, through the antenna unit 204.

The feedback information obtaining unit 206 detects and obtains feedback information that has been transmitted from each terminal device 300, from the signal received by the uplink reception unit 205. The feedback information obtaining unit 206 calculates a desired pre-coding matrix WFB which is selected by each terminal device 300, and a corresponding MU-CQI, based on the obtained feedback information and past feedback information that is stored in the feedback information storage unit 207. In addition, the details about a feedback information acquisition operation will be described later.

The feedback information storage unit 207 stores the feedback information that is obtained by the feedback information obtaining unit 206.

The base station control unit 201 performs allocation (scheduling) of radio resources, based on each desired pre-coding matrix WFB of each terminal device 300 and the corresponding MU-CQI, which are calculated by the feedback information obtaining unit 206, and the accumulated amount, the priority, the allowable delay time, and the like of the transmission data addressed to each terminal device 300, and selects a plurality of terminal devices 300 which are to be subjected to the MU-MIMO transmission among them.

The pre-coding matrix calculation unit 202 calculates a pre-coding matrix W_{TX} that is actually used in the MU-MIMO transmission of the transmission data addressed to the plurality of terminal devices 300, based on the plurality of desired pre-coding matrices WFB respectively corresponding to the plurality of terminal devices 300 which are to be subjected to the MU-MIMO transmission, which are selected by the base station control unit 201, and the MU-CQI, and determines the modulation scheme and the coding rate for the transmission data addressed to each terminal device 300. In addition, a transport block size indicating the number of bits of the transmission data for the radio resource may be determined as a parameter equivalent to the coding rate. In addition, the details of the calculation of the pre-coding matrix W_{TX} will be described later.

The downlink transmission unit 203 generates a downlink transmit signal addressed to each terminal device 300, and transmits it through the antenna unit 204. In this case, the downlink transmission unit 203 performs error correction coding, rate matching (puncturing), and modulation on the transmission data addressed to the plurality of terminal devices 300 which are to be subjected to MU-MIMO transmission, based on the coding rate and the modulation scheme that are determined by the pre-coding matrix calculation unit 202, and performs pre-coding by multiplying the transmission data by the pre-coding matrix W_{TX} that is calculated by the pre-coding matrix calculation unit 202. Further, each terminal device 300 transmits known reference signals, for example, a cell-specific reference signal (CRS) and a channel state information reference signal (CSI-RS), in order to estimate a channel state between each antenna of the base station device 200 and each antenna of the terminal device 300.

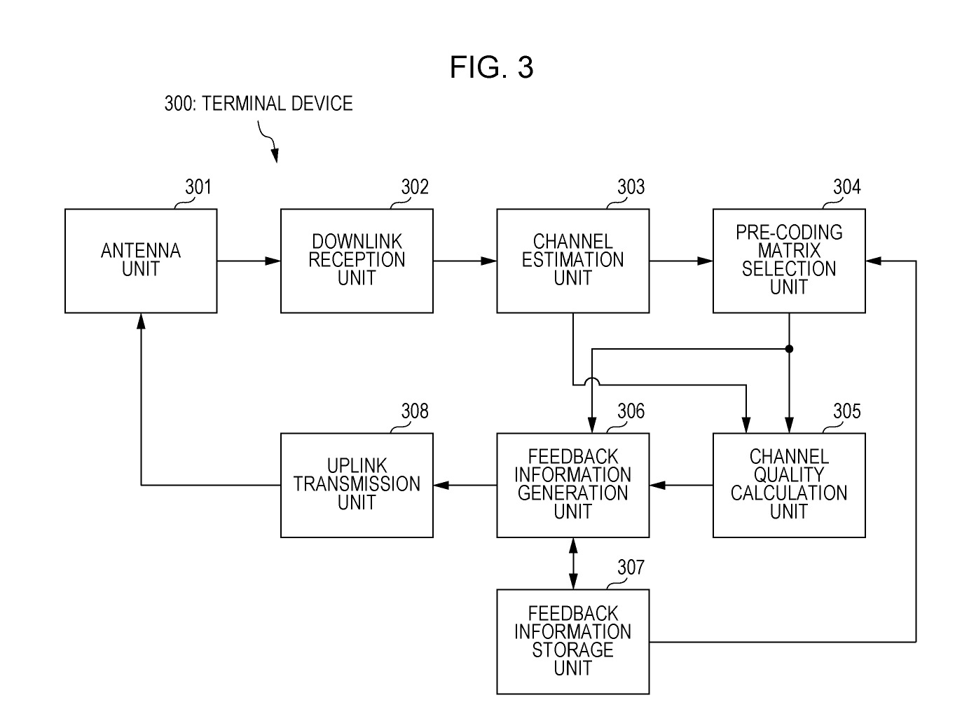

FIG. 3 is a functional block diagram illustrating a configuration example of a terminal device 300 of the present invention. In FIG. 3, the terminal device 300 is configured with an antenna unit 301, a downlink reception unit 302, a channel estimation unit 303, a pre-coding matrix selection unit 304, a channel quality calculation unit 305, a feedback information generation unit 306, a feedback information storage unit 307, and an uplink transmission unit 308.

The antenna unit 301 includes at least one transmission and reception antenna, receives a downlink radio signal, and transmits an uplink radio signal.

The downlink reception unit 302 receives a downlink transmit signal that is transmitted from the base station device 200, through the antenna unit 301.

The channel estimation unit 303 extracts a reference signal from the signal that is received by the downlink reception unit 302, and estimates a channel state, for example, a complex channel gain and the like between each antenna of the base station device 200 (or an antenna port which is a virtual transmission antenna) and at least one antenna of the terminal device, based on the extracted reference signal.

The pre-coding matrix selection unit 304 selects one desired pre-coding matrix W_{FB}, among pre-coding matrices W generated by combining a first pre-coding matrix W₁ and a second pre-coding matrix W₂ which are respectively selected one by one from a first codebook and a second codebook, based on the channel state estimation result by the channel estimation unit 303, at a first feedback timing. In the selection of the desired pre-coding matrix WFB, when the base station device 200 performs pre-coding by using each pre-coding matrix W of the selection candidate, in the estimated channel state, it is preferable to select a pre-coding matrix W which allows the maximization of SINR or throughput of the terminal device. For example, the desired pre-coding matrix W_{FB} is obtained based on Expression (1).

$$\begin{matrix}[ Math 1 ] & \\ {W}_{FB} = {arg max}_{W ; W ⋐ C} ( {‖ HW ‖}^{2} ) & ( 1 )\end{matrix}$$

In Expression (1), H represents a channel matrix with elements as complex channel gains between each transmission antenna of the base station device 200 and each reception antenna of the terminal device, which is estimated by the channel estimation unit 303, C represents a set of candidates for the pre-coding matrix W, ∥x∥ represents a norm of x, and argmaxₓ(f(x)) represents a function for selecting x to maximize an evaluation function f(x).

Further, the pre-coding matrix selection unit 304 reselects only the second pre-coding matrix W₂, based on the estimation result of the channel state of the channel estimation unit 303 on the same basis as Expression (1), under a condition of using the first pre-coding matrix W₁ as it is which has been selected most recently and stored in the feedback information storage unit 307, at the second feedback timing, and selects a new desired pre-coding matrix W_{FB}.

The channel quality calculation unit 305 calculates MU-CQI which is the channel quality in consideration of the inter-user interference, in the case of assuming that the base station device 200 performs MU-MIMO transmission by performing pre-coding using the desired pre-coding matrix WFB, based on the desired pre-coding matrix WFB selected by the pre-coding matrix selection unit 304 and the channel estimation result of the channel estimation unit 303. For example, SINR(γ_{MU}) occurring when data are pre-coded and subject to MU-MIMO transmission by using the desired pre-coding matrix W_{FB} for the data addressed to the terminal device, and using the pre-coding matrix W other than the desired pre-coding matrix W_{FB} for the data addressed to another terminal device, is calculated based on Expression (2).

$$\begin{matrix}[ Math 2 ] & \\ {γ}_{MU} = \frac{{\vert {b}^{H} {HW}_{FB} \vert}^{2}}{{\sum }_{W ⋐ C , W \neq {W}_{FB}} {\vert {b}^{H} HW \vert}^{2} + \frac{M}{P} {‖ b ‖}^{2}} & ( 2 )\end{matrix}$$

In Expression (2), it is assumed a case in which the number of transmission antennas provided in the base station device 200 is M, the number U of terminal devices that are multiplexed in MU-MIMO is equal to M, and one stream is transmitted to each terminal device. In Expression (2), b represents a reception filter such as a minimum mean square error (MMSE) norm obtained based on a channel matrix H, the superscript H represents Hermitian transpose, and P represents the total transmission power.

In addition, the terminal device 300 calculates MU-CQI assuming a case where a pre-coding matrix W_{BC} (Best Companion) having the most orthogonality to the desired pre-coding matrix W_{FB} is used for another terminal device, and at the same time, the base station device 200 may be notified of information on the pre-coding matrix W_{BC}.

In addition, the terminal device 300 calculates PMI₁ and PMI₂ associated with a rank following the desired rank, in addition to the PMI₁ and the PMI₂ associated with the desired rank, and may notify the base station device 200 of CQI that is calculated based on the PMI₁ and the PMI₂ associated with a rank following the desired rank as MU-CQI.

The feedback information generation unit 306, at the first feedback timing, generates feedback information PMI₁ and PMI₂ indicating the respective numbers of the first pre-coding matrix W₁ and the second pre-coding matrix W₂ constituting the desired pre-coding matrix W_{FB} selected by the pre-coding matrix selection unit 304, and generates feedback information CQI_{MU} indicating MU-CQI calculated by the channel quality calculation unit 305.

Further, the feedback information generation unit 306 generates PMI₂ indicating the number of second pre-coding matrix W₂ which is reselected, and ΔCQI_{MU} which is the number corresponding to a difference value between MU-CQI which is stored in the feedback information storage unit 307 and is fed back at the most recent (MU-CQI value corresponding to CQI_{MU} that is most recently fed back) and the latest MU-CQI that is calculated by the channel quality calculation unit 305, at the second feedback timing. In addition, the details of the generation of the feedback information will be described later.

The feedback information storage unit 307 stores feedback information that is generated by the feedback information generation unit 306. In addition, in the present embodiment, it is sufficient to store PMI₁ and CQI_{MU}.

The uplink transmission unit 308 transmits the feedback information generated by the feedback information generation unit 306, to the base station device 200, through the antenna unit 301.

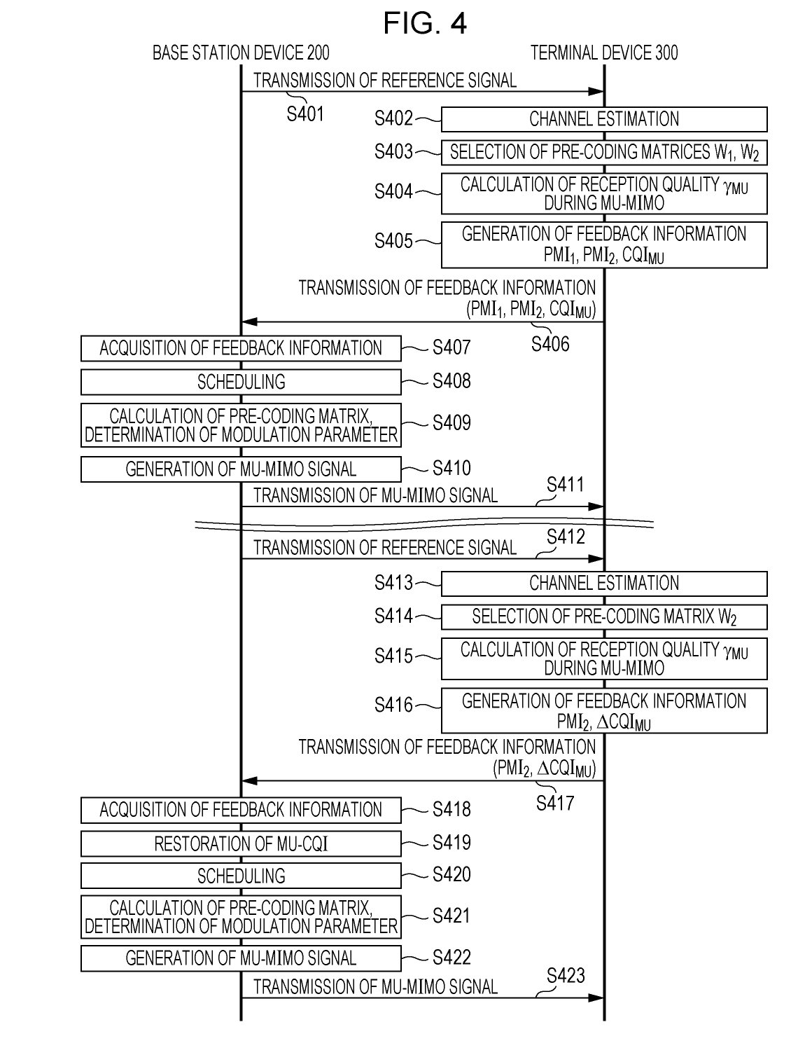

FIG. 4 is a sequence chart illustrating an example of transmission and reception of feedback information between the base station device 200 and the terminal device 300 according to the present embodiment.

First, the base station device 200 transmits reference signals such as CRS and CSI-RS to the terminal device 300 (step S401).

The terminal device 300 receives the reference signal that the base station device 200 has transmitted, and estimates the channel state between each antenna of the base station device 200 and each antenna of the terminal device, based on the received reference signal (step S402).

Here, assuming the case at the first feedback timing, the terminal device 300 selects the desired pre-coding matrix WFB by respectively selecting the first pre-coding matrix W₁ from the first codebook and the second pre-coding matrix W₂ from the second codebook, based on the estimation result of the channel state (step S403).

Further, the terminal device 300 calculates the MU-CQI value γ_{MU}, using Expression (2) or the like, based on the estimation result of the channel state and the desired pre-coding matrix W_{FB} selected in step S403 (step S404).

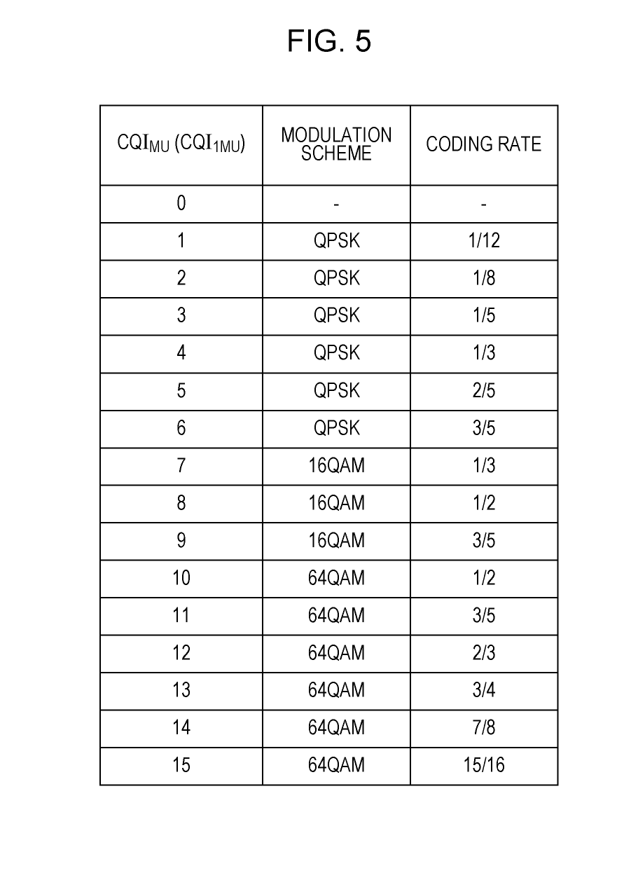

The terminal device 300 generates feedback information PMI₁ and PMI₂ indicating the respective numbers of the first pre-coding W₁ and the second pre-coding matrix W₂ which are selected in S403, and feedback information CQI_{MU} indicating MU-CQI calculated in step S404 (step S405). For example, the terminal device 300 selects the combination that can satisfy a required block error rate, a required packet error rate, a required frame error rate, or the like when the SINR is γ_{MU}, based on γ_{MU} calculated in step S404, from a table of combinations of the modulation scheme and the coding rate as illustrated in FIG. 5, and generates the number as feedback information CQI_{MU} indicating the MU-CQI. For example, in FIG. 5, when the SINR is γ_{MU}, the terminal device 300 generates CQI_{MU}=7 when a combination capable of realizing a maximum transmission speed is a combination of 16 quadrature amplitude modulation (QAM) and the coding rate 1/3, among combinations of the modulation scheme and the coding rate which satisfy the required block error rate 0.1. In addition, the value obtained by quantizing γ_{MU} which is the value of the calculated SINR as it is may be used as the CQI_{MU}. Further, the CQI_{MU} may be calculated based on the effective Signal to Noise power Ratio (SNR) that is calculated with respect to the γ_{MU} which is calculated in step S404, based on a method such as an effective signal-to-noise power ratio mapping method.

The terminal device 300 transmits the feedback information PMI₁, PMI₂, and CQI_{MU} which are generated in step S405, to the base station device 200 (step S406).

The base station device 200 receives the signal that the terminal device 300 has transmitted, and obtains the feedback information PMI₁, PMI₂ and CQI_{MU} (step S407). Further, the base station device 200 obtains the desired pre-coding matrix WFB of the terminal device 300, from the obtained PMI₂ and PMI₂.

The base station device 200 performs scheduling, based on the desired pre-coding matrix WFB of each terminal device 300, a respectively corresponding MU-CQI (CQI_{MU}), and the accumulated amount, the priority, the allowable delay time, and the like of the transmission data addressed to each terminal device 300, and selects a plurality of terminal devices 300 which are to be subjected to the MU-MIMO transmission among them (step S408). For example, since a terminal device 300 representing the MU-CQI of high quality indicates a higher orthogonality of a channel as compared to another terminal device 300, the base station device 200 may perform scheduling so as to preferentially spatially multiplex the terminal device 300 having the MU-CQI indicating high quality. In particular, if each terminal device 300 notifies of W_{BC}, for example, W_{BC} that is notified from the terminal device 300-1 and W_{FC} that is notified from the terminal device 300-2 match each other, and at the same time, W_{BC} that is notified from the terminal device 300-2 and W_{FB} that is notified from the terminal device 300-1 match each other, the channel between the base station device 200 and the terminal device 300-1 and the channel between the base station device 200 and the terminal device 300-2 have high orthogonality with each other, such that it is preferable that the base station device 200 to perform scheduling so as to spatially multiplex a plurality of terminal devices 300 having such a relationship.

The base station device 200 calculates a pre-coding matrix W_{TX} based on a plurality of desired pre-coding matrices W_{FB} respectively corresponding to the plurality of terminal devices 300 which are selected as targets of MU-MIMO transmission, and determines a modulation scheme and a coding rate for transmission data of each terminal device 300 based on each similarly corresponding MU-CQI (CQI_{MU}) (step S409). For example, when two terminal devices 300-1 and 300-2 are selected for MU-MIMO transmission, if the desired pre-coding matrices W_{FB} which have respectively been notified are assumed as W_{FB1} and W_{FB2}, the base station device 200 regards the channel matrix H_{eff} between the transmission antenna and the respective reception antennas of the terminal devices 300-1 and 300-2 as H_{eff}=[W_{FB1}, W_{FB2}]^{H}, and may obtain the pre-coding matrix W_{TX} as W_{TX}=H⁺_{eff}=H^{H}_{eff}(H_{eff}H^{H}_{eff})⁻¹. In addition, here, H⁺_{eff} is the general inverse matrix of H_{eff}, and X⁻¹ is the inverse matrix of the matrix X.

The base station device 200 generates a MU-MIMO signal by performing error correction coding, rate matching, and modulation on the transmission data addressed to each terminal device 300, based on the coding rate and the modulation scheme that are determined in step S409, and by performing pre-coding by multiplying the transmission data by the calculated pre-coding matrix W_{TX} (step S410), and transmits the generated MU-MIMO signal to each terminal device 300 (step S411).

Next, the base station device 200 transmits again the reference signal such as the CRS and CSI-RS to the terminal device 300 (step S412).

The terminal device 300 receives the reference signal that the base station device 200 has transmitted, and estimates the channel state between each antenna of the base station device 200 and each antenna of the terminal device, based on the received reference signal (step S413).

Here, assuming the case at the second feedback timing, the terminal device 300 selects desired pre-coding matrix W_{FB} by reselecting only the second pre-coding matrix W₂ from the second codebook, based on the estimation result of the channel state, assuming that the pre-coding matrix W₁ corresponding to PMI₁ that has been notified in step S406 (the first pre-coding matrix which has most recently been notified selected and notified to the base station device 200) is used as it is as the first pre-coding matrix W₁ (step S414).

The terminal device 300 calculates the value γ_{MU} of MU-CQI by using Expression (2), based on the estimation result of the channel state and the desired pre-coding matrix W_{FB} selected in step S414 (step S415).

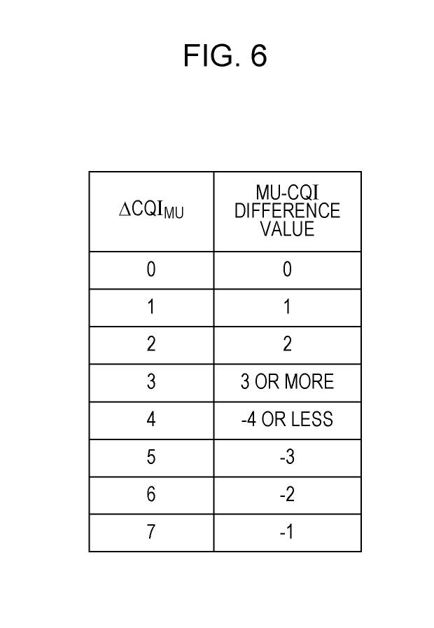

The terminal device 300 generates feedback information PMI₂ indicating the number of the second pre-coding matrix W₂ which is selected in step S414, obtains feedback information CQI_{MU} indicating MU-CQI based on the γ_{MU} calculated in step S415, calculates a difference value (a MU-CQI difference value) with the CQI_{MU} (the CQI_{MU} that is most recently notified to the base station device 200 along with the PMI₁ and the PMI₂) that is generated in step S405, and generates feedback information ΔCQI_{MU} indicating the MU-CQI difference value (step S416). In addition, it is preferable that the ΔCQI_{MU} is generated based on, for example, a table of the MU-CQI difference value and ΔCQI_{MU} illustrated in FIG. 6, but may be generated based on a method capable of realizing the ΔCQI_{MU} with an information amount (the number of bits) less than the CQI_{MU} without being limited thereto.

The terminal device 300 transmits the feedback information PMI₂ and ΔCQI_{MU} which are generated in step S416, to the base station device 200 (step S417).

The base station device 200 receives the signal that the terminal device 300 has transmitted, and obtains the feedback information PMI₂ and ΔCQI_{MU} (step S418). Further, the base station device 200 obtains the desired pre-coding matrix W_{FB} of the terminal device 300, from the obtained PMI₂, and PMI₁ which has most recently been notified from the terminal device 300.

The base station device 200 restores the MU-CQI (CQI_{MU} that is fed back at the present time) by adding ΔCQI_{MU} that is obtained in step S418 and the CQI_{MU} that is notified at the feedback timing when the PMI₁ has most recently been notified from the terminal device 300 (step S419).

The base station device 200 performs scheduling, based on the desired pre-coding matrix W_{FB} of each terminal device 300, a respectively corresponding MU-CQI which is restored in step S419, and the accumulated amount, the priority, the allowable delay time, and the like of the transmission data addressed to each terminal device 300, and selects a plurality of terminal devices 300 which are to be subjected to the MU-MIMO transmission among them (step S420).

The base station device 200 calculates a pre-coding matrix W_{TX} based on a plurality of desired pre-coding matrices W_{FB} respectively corresponding to a plurality of terminal devices 300 which are selected as MU-MIMO transmission targets, and determines a modulation scheme and a coding rate for transmission data of each terminal device 300 based on each similarly corresponding MU-CQI that is restored in step S419 (step S421).

The base station device 200 generates a MU-MIMO signal by performing error correction coding, rate matching, and modulation on the transmission data addressed to each terminal device 300, based on the coding rate and the modulation scheme that are determined in step S421, and by performing pre-coding by multiplying the transmission data by the calculated pre-coding matrix W_{TX} (step S422), and transmits the generated MU-MIMO signal to each terminal device 300 (step S423).

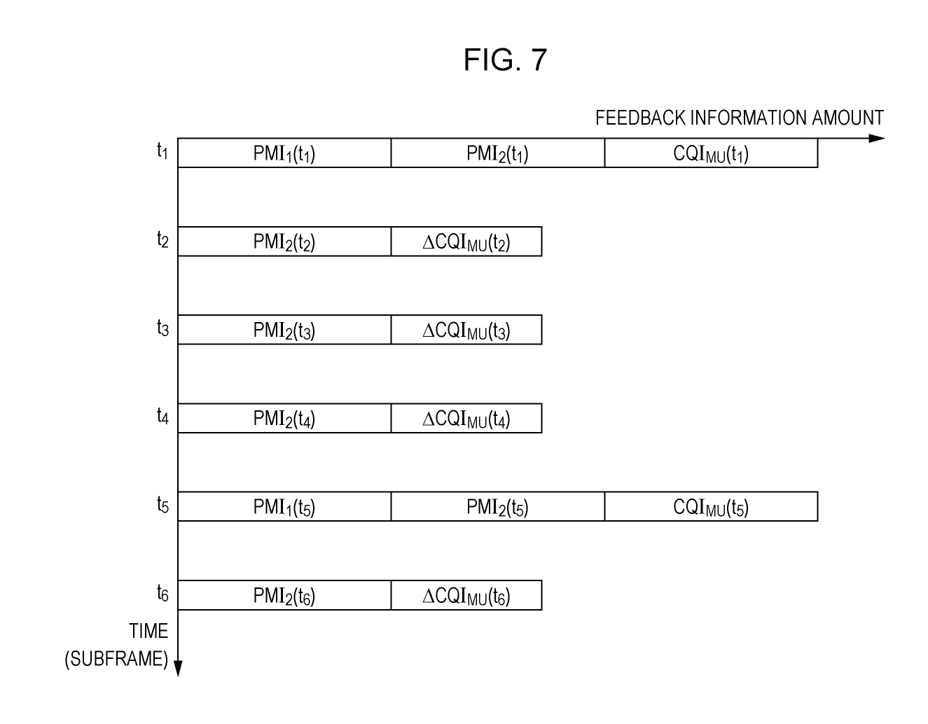

FIG. 7 is a diagram illustrating an example of feedback information that is transmitted and received between the base station device 200 and the terminal device 300 according to the present embodiment.

In FIG. 7, times t₄ to t₆ represent feedback timings when feedback from the terminal device 300 is performed, times t₄ and is are first feedback timings, and times t₂, t₃, t₄ and t₆ are second feedback timings. Further, PMI₁(t), PMI₂(t), CQI_{MU} (t) and ΔCQI_{MU}(t) represent PMI₁, PMI₂, CQI_{MU} and ΔCQI_{MU} at respective timings.

At the time t₁ which is the first feedback timing, the terminal device 300 selects the first pre-coding matrix W₁ and the second pre-coding matrix W₂, and notifies the base station device 200 of the PMI₁(t₁) and PMI₂(t₁) which respectively correspond thereto, and CQI_{MU}(t₁) representing the MU-CQI.

At the time t₂ which is the second feedback timing, assuming that the first pre-coding matrix W₁ corresponding to PMI₁(t₁) which is PMI₁ that has most recently been notified to the base station device 200 is used as it is, the terminal device 300 reselects the second pre-coding matrix W₂, notifies the base station device 200 of PMI₂(t₂) indicating the number, calculates CQI_{MU}(t₂) indicating MU-CQI based on the desired pre-coding matrix WFB which is indicated by PMI₁(t₁) and PMI₂(t₂), obtains ΔCQI_{MU}(t₂) from a difference value between CQI_{MU}(t₂) and CQI_{MU}(t₁), and notifies the base station device 200 of the obtained ΔCQI_{MU}(t₂). The base station device 200 calculates (restores) CQI_{MU}(t₁)+ΔCQI_{MU}(t₂) as a value of MU-CQI which is fed back at the time t₂.

Also at the time t₃ which is the second feedback timing, similarly to the time t₂, assuming that the first pre-coding matrix W₁ corresponding to PMI₁(t₁) which is PMI₁ that has most recently been notified to the base station device 200 is used as it is, the terminal device 300 reselects the second pre-coding matrix W₂, notifies the base station device 200 of PMI₂(t₃) indicating the number, calculates CQI_{MU}(t₃) indicating MU-CQI based on the desired pre-coding matrix W_{FB} which is indicated by PMI₁(t₁) and PMI₂(t₃), obtains ΔCQI_{MU}(t₃) from a difference value between CQI_{MU}(t₃) and CQI_{MU}(t₁), and notifies the base station device 200 of the obtained ΔCQI_{MU}(t₃). The base station device 200 calculates CQI_{MU}(t₁)+ΔCQI_{MU}(t₃) as a value of MU-CQI which is fed back at the time t₃. Feedback is also performed similarly at the time t₄.

At the time t₅ which is the first feedback timing, similarly to the time t₁, the terminal device 300 selects the first pre-coding matrix W₁ and the second pre-coding matrix W₂, and notifies the base station device 200 of the PMI₁(t₅) and PMI₂(t₅) which respectively correspond thereto, and CQI_{MU}(t₅) representing the MU-CQI.

Also at the time t₆ which is the second feedback timing, similarly to the times t₂, t₃ and t₄, assuming that the first pre-coding matrix W₁ corresponding to PMI₁(t₅) which is PMI₁ that has most recently been notified to the base station device 200 is used as it is, the terminal device 300 reselects the second pre-coding matrix W₂, notifies the base station device 200 of PMI₂(t₆) indicating the number, calculates CQI_{MU}(t₆) indicating MU-CQI based on the desired pre-coding matrix W_{FB} which is indicated by PMI₁(t₅) and PMI₂(t₆), obtains ΔCQI_{MU}(t₆) from a difference value between CQI_{MU}(t₆) and CQI_{MU}(t₅), and notifies the base station device 200 of the obtained ΔCQI_{MU}(t₆). The base station device 200 calculates (restores) CQI_{MU}(t₅)+ΔCQI_{MU}(t₆) as a value of MU-CQI which is fed back at the time t₆. Hereinafter, a feedback process is performed similarly.

As described above, in the present embodiment, when the terminal device 300 feeds back the information on the desired pre-coding matrix to the base station device 200, in the case of notifying PMI₁ and PMI₂ indicating the numbers of the first pre-coding matrix W₁ and the second pre-coding matrix W₂, the CQI_{MU} indicating the MU-CQI is also notified; and in the case of notifying only PMI₂, ΔCQI_{MU} indicating the difference value from CQI_{MU} which has most recently been notified along with PMI₁ and PMI₂, for the MU-CQI. In other words, in the present embodiment, the terminal device 300 simultaneously notifies of the CQI_{MU} indicating the MU-CQI at the first feedback timing when the information PMI₁ on the first pre-coding matrix W₁ is fed back, simultaneously notifies of ΔCQI_{MU} indicating the difference value from MU-CQI corresponding to CQI_{MU} which has most recently been notified for the MU-CQI at the second feedback timing when the information PMI₂ on the second pre-coding matrix W₂ is fed back, and simultaneously notifies of the CQI_{MU} indicating the MU-CQI, when the feedback timings of PMI₁ and PMI₂ match each other.

Therefore, the base station device 200 can select proper modulation scheme and coding rate for transmission data addressed to each terminal device 300 based on the channel quality MU-CQI during the MU-MIMO transmission, and improve a throughput performance in the base station device 200, and the terminal device 300 can reduce the amount of information required for feedback of the MU-CQI.

### Second Embodiment

The schematic configuration example of a radio communication system of the present embodiment is illustrated in FIG. 1, similarly to the first embodiment. Further, the configuration of the base station device 200 is similar to FIG. 2, and the process of the feedback information obtaining unit 206 is different from the first embodiment. The configuration of the terminal device 300 is similar to FIG. 3, and the processes of the channel quality calculation unit 305 and the feedback information generation unit 306 are different from the first embodiment. In the following, with respect to the radio communication system of the present embodiment, components different from the first embodiment will be described and components similar to the first embodiment will not be described.

In the present embodiment, at the first feedback timing, the terminal device 300 calculates the MU-CQI (hereinafter, referred to as the partial MU-CQI) in the case of assuming that the base station device 200 performs pre-coding by using only the selected first pre-coding matrix W₁, combines the terminal device 300 with other terminal devices, and performs MU-MIMO transmission, and the MU-CQI similar to the first embodiment in the case of assuming that the base station device 200 performs pre-coding by using only the desired pre-coding matrix W_{FB} (=W₁W₂) and performs MU-MIMO transmission (hereinafter, also referred to as an entire MU-CQI, and is assumed to refer to the entire MU-CQI when simply referred to as MU-CQI).

The terminal device 300 notifies the base station device 200 of PMI₁ and PMI₂ respectively indicating the numbers of the first pre-coding matrix W₁ and the second pre-coding matrix W₂, which are selected, CQI_{1MU} which is a number indicating partial MU-CQI, and ΔCQI_{MU} which is a number indicating a difference value between an entire MU-CQI and the partial MU-CQI, at the first feedback timing, and notifies the base station device 200 of PMI₂ indicating the number of the second pre-coding matrix W₂ which is reselected, and ΔCQI_{MU} which is a number indicating a difference value between an entire MU-CQI that is newly calculated and the partial MU-CQI which has been notified at the most recent first feedback timing, at the second feedback timing. Further, the terminal device 300 may notify the base station device 200 of information (RI) regarding the number of ranks of MIMO.

The base station device 200 obtains feedback information PMI₁, PMI₂, CQI_{MU} and ΔCQI_{MU}, or PMI₂ and ΔCQI_{MU} which have been notified from each terminal device 300, and performs pre-coding on the transmission data addressed to each terminal device 300 based on the information. Further, prior to the pre-coding, it is preferable to perform adaptive modulation for determining a modulation scheme and a coding rate on the transmission data addressed to each terminal device 300, based on the (entire) MU-CQI that is indicated by the addition result of CQI_{MU} and ΔCQI_{MU} that have been notified from each terminal device 300. The base station device 200 spatially multiplexes the transmission data subjected to the pre-coding into the same radio resource and transmits it.

In FIG. 3, the channel quality calculation unit 305 according to the terminal device 300 of the present embodiment calculates the partial MU-CQI in the case of assuming that the base station device 200 combines the terminal device 300 with another terminal device by performing pre-coding by using only the selected first pre-coding matrix W₁ and performs MU-MIMO transmission, in addition to the MU-CQI (entire MU-CQI) in the case of assuming that the base station device 200 performs pre-coding by using the desired pre-coding matrix WFB selected by the pre-coding matrix selection unit 304 and performs MU-MIMO transmission. The partial MU-CQI can be calculated by Expression using W₂ instead of W_{FB} in, for example, Expression (2).

The feedback information generation unit 306 according to the terminal device 300 of the present embodiment, at the first feedback timing, generates feedback information PMI₁ and PMI₂ indicating the respective numbers of the first pre-coding matrix W₁ and the second pre-coding matrix W₂ constituting the desired pre-coding matrix WFB selected by the pre-coding matrix selection unit 304, and generates feedback information CQI_{1MU} indicating the partial MU-CQI calculated by the channel quality calculation unit 305, and ΔCQI_{MU} which is a number indicating a difference value between the entire MU-CQI and the partial MU-CQI.

Further, the feedback information generation unit 306 generates PMI₂ indicating the number of the second pre-coding matrix W₂ which is reselected, and ΔCQI_{MU} which is the number indicating a difference value between the entire MU-CQI and the partial MU-CQI which is stored in the feedback information storage unit 307 and is notified at the most recent first feedback timing, at the second feedback timing. In addition, the details of the generation of the feedback information will be described later.

The feedback information storage unit 307 stores feedback information that is generated by the feedback information generation unit 306. In addition, in the present embodiment, it is sufficient to store PMI₁ and CQI_{1MU}.

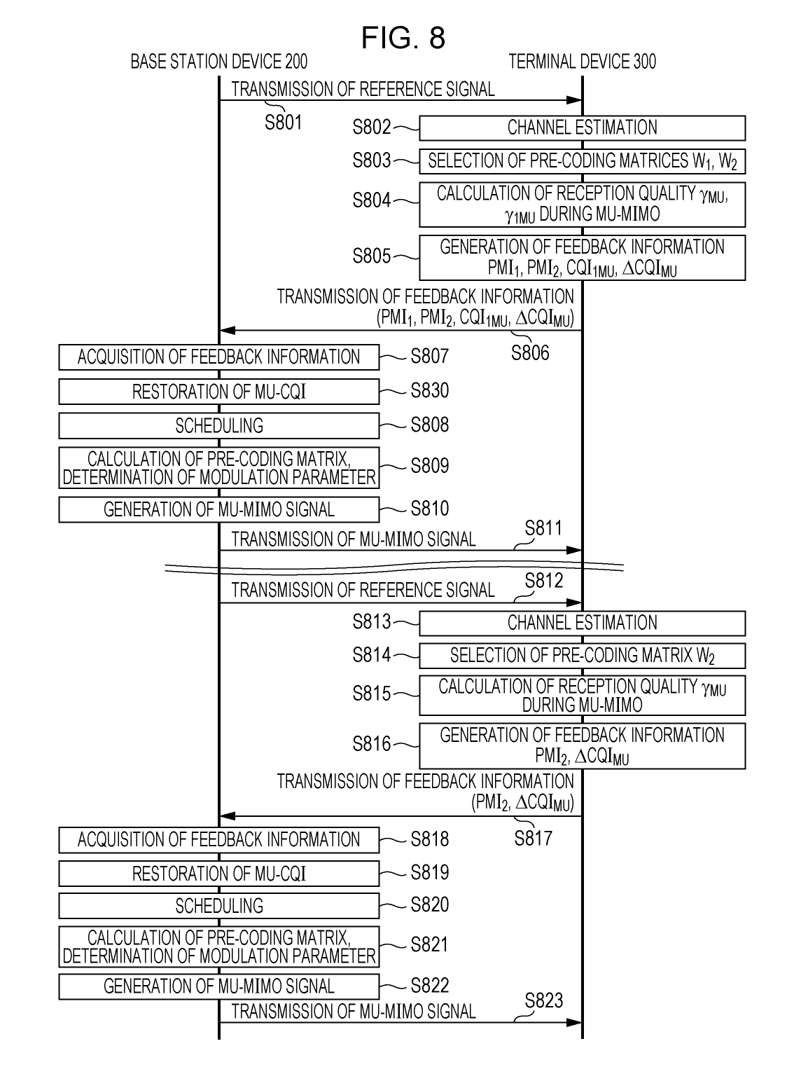

FIG. 8 is a sequence chart illustrating an example of transmission and reception of feedback information between the base station device 200 and the terminal device 300 according to the present embodiment.

First, the base station device 200 transmits reference signals such as CRS and CSI-RS to the terminal device 300 (step S801).

The terminal device 300 receives the reference signal that the base station device 200 has transmitted, and estimates the channel state between each antenna of the base station device 200 and each antenna of the terminal device, based on the received reference signal (step S802).

Here, assuming the case at the first feedback timing, the terminal device 300 selects the desired pre-coding matrix WFB by respectively selecting the first pre-coding matrix W₁ from the first codebook and the second pre-coding matrix W₂ from the second codebook, based on the estimation result of the channel state (step S803).

Further, the terminal device 300 calculates the entire MU-CQI value γ_{MU} and the partial MU-CQI value γ_{1MU}, using Expression (2) and the like, based on the estimation result of the channel state, the desired pre-coding matrix W_{FB} selected in step S803, and the first pre-coding matrix W₁ (step S804).

The terminal device 300 generates feedback information PMI₁ and PMI₂ indicating the respective numbers of the first pre-coding W₁ and the second pre-coding matrix W₂ which are selected in S803, feedback information CQI_{1MU} indicating partial MU-CQI calculated in step S804, and feedback information ΔCQI_{MU} indicating a difference value between the entire MU-CQI and the partial MU-CQI (step S805).

For example, the terminal device 300 selects the combination that can satisfy a required block error rate, a required packet error rate, a required frame error rate, or the like when the SINR is γ_{1MU}, based on γ_{1MU} calculated in step S804, from a table of combinations of the modulation scheme and the coding rate as illustrated in FIG. 5, and generates the number as feedback information CQI_{1MU} indicating the partial MU-CQI. For example, in FIG. 5, when the SINR is γ_{1MU}, the terminal device 300 generates CQI_{1MU}=7 when a combination capable of realizing a maximum transmission speed is a combination of the modulation scheme 16 QAM and the coding rate 1/3, among combinations of the modulation scheme and the coding rate which satisfy the required block error rate 0.1. In addition, the value obtained by quantizing γ_{1MU} which is the value of the calculated SINR as it is may be used as the CQI_{1MU}.

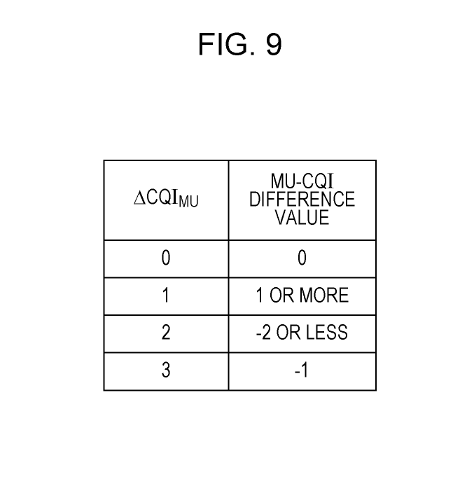

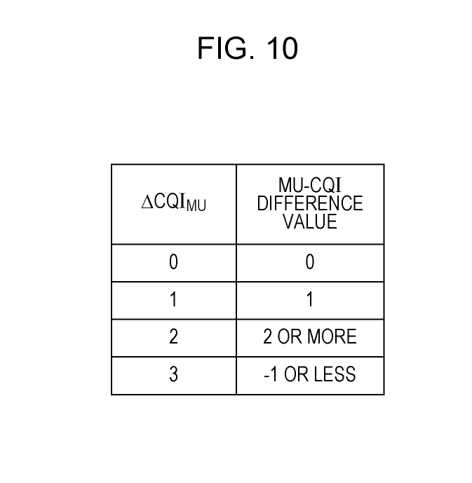

Further, it is preferable that the ΔCQI_{MU} is generated, for example, based on a table of the MU-CQI difference value and ΔCQI_{MU} illustrated in FIG. 9 and FIG. 10, but may be generated by a method capable of realizing the ΔCQI_{MU} with an information amount (the number of bits) less than the CQI_{1MU} without being limited thereto.

The terminal device 300 transmits the feedback information PMI₁, PMI₂, CQI_{1MU}, and ΔCQI_{MU} which are generated in step S805, to the base station device 200 (step S806).

The base station device 200 receives the signal that the terminal device 300 has transmitted, and obtains the feedback information PMI₁, PMI₂, CQI_{1MU}, and ΔCQI_{MU} (step S807). Further, the base station device 200 obtains the desired pre-coding matrix W_{FB} of the terminal device 300, from the obtained PMI₁ and PMI₂.

The base station device 200 restores entire MU-CQI by adding CQI_{1MU} and ΔCQI_{MU} that are obtained in step S807 (step S830).

The base station device 200 performs scheduling, based on the desired pre-coding matrix WFB of each terminal device 300, each corresponding MU-CQI, and the accumulated amount, the priority, the allowable delay time, and the like of the transmission data addressed to each terminal device 300, and selects a plurality of terminal devices 300 which are to be subjected to the MU-MIMO transmission among them (step S808).

The base station device 200 calculates a pre-coding matrix W_{TX} based on a plurality of desired pre-coding matrices W_{FB} respectively corresponding to a plurality of terminal devices 300 which are selected as MU-MIMO transmission targets, and determines a modulation scheme and a coding rate for transmission data of each terminal device 300 based on each similarly corresponding MU-CQI (step S809).

The base station device 200 generates a MU-MIMO signal by performing error correction coding, rate matching, and modulation on the transmission data addressed to each terminal device 300, based on the coding rate and the modulation scheme that are determined in step S809, and by performing pre-coding by multiplying the transmission data by the calculated pre-coding matrix W_{TX} (step S810), and transmits the generated MU-MIMO signal to each terminal device 300 (step S811).

Next, the base station device 200 transmits again the reference signal such as the CRS and CSI-RS to the terminal device 300 (step S812).

The terminal device 300 receives the reference signal that the base station device 200 has transmitted, and estimates the channel state between each antenna of the base station device 200 and each antenna of the terminal device, based on the received reference signal (step S813).

Here, assuming the case at the second feedback timing, the terminal device 300 selects the desired pre-coding matrix WFB by reselecting only the second pre-coding matrix W₂ from the second codebook, based on the estimation result of the channel state, assuming that the pre-coding matrix W₁ corresponding to PMI₁ that has been notified in step S806 (the first pre-coding matrix which has most recently notified to the base station device 200) is used as it is as the first pre-coding matrix W₁ (step S814).

The terminal device 300 calculates the value γ_{MU} of entire MU-CQI by using Expression (2), based on the estimation result of the channel state and the desired pre-coding matrix W_{FB} selected in step S814 (step S815).

The terminal device 300 generates feedback information PMI₂ indicating the number of the second pre-coding matrix W₂ selected in step S814, obtains feedback information CQI_{MU} indicating the entire MU-CQI based on γ_{MU} calculated in step S815, calculates a difference value (an MU-CQI difference value) with the CQI_{1MU} which is the partial MU-CQI generated in step S805, and generates feedback information ΔCQI_{MU} indicating the MU-CQI difference value (step S816). In addition, it is preferable that the ΔCQI_{MU} is generated based on, for example, a table of the MU-CQI difference value and ΔCQI_{MU} illustrated in FIG. 9 and FIG. 10, but may be generated based on a method capable of realizing the ΔCQI_{MU} with an information amount (the number of bits) less than the CQI_{1MU} without being limited thereto.

The terminal device 300 transmits the feedback information PMI₂ and ΔCQI_{MU} which are generated in step S816, to the base station device 200 (step S817).

The base station device 200 receives the signal that the terminal device 300 has transmitted, and obtains the feedback information PMI₂ and ΔCQI_{MU} (step S818). Further, the base station device 200 obtains the desired pre-coding matrix WFB of the terminal device 300, from the obtained PMI₂, and PMI₁ which has most recently been notified from the terminal device 300.

The base station device 200 restores entire MU-CQI by adding ΔCQI_{MU} that is obtained in step S818 and the CQI_{1MU} that is partial MU-CQI which is most recently notified from the terminal device 300 (step S819).

The base station device 200 performs scheduling, based on the desired pre-coding matrix W_{FB} of each terminal device 300, each corresponding MU-CQI that is restored in step S819, and the accumulated amount, the priority, the allowable delay time, and the like of the transmission data addressed to each terminal device 300, and selects a plurality of terminal devices 300 which are to be subjected to the MU-MIMO transmission among them (step S820).

The base station device 200 calculates a pre-coding matrix W_{TX} based on a plurality of desired pre-coding matrices W_{FB} respectively corresponding to a plurality of terminal devices 300 which are selected as MU-MIMO transmission targets, and determines a modulation scheme and a coding rate for transmission data of each terminal device 300 based on each similarly corresponding MU-CQI that is restored in step S819 (step S821).

The base station device 200 generates a MU-MIMO signal by performing error correction coding, rate matching, and modulation on the transmission data addressed to each terminal device 300, based on the coding rate and the modulation scheme that are determined in step S821, and by performing pre-coding by multiplying the transmission data by the calculated pre-coding matrix W_{TX} (step S822), and transmits the generated MU-MIMO signal to each terminal device 300 (step S823).

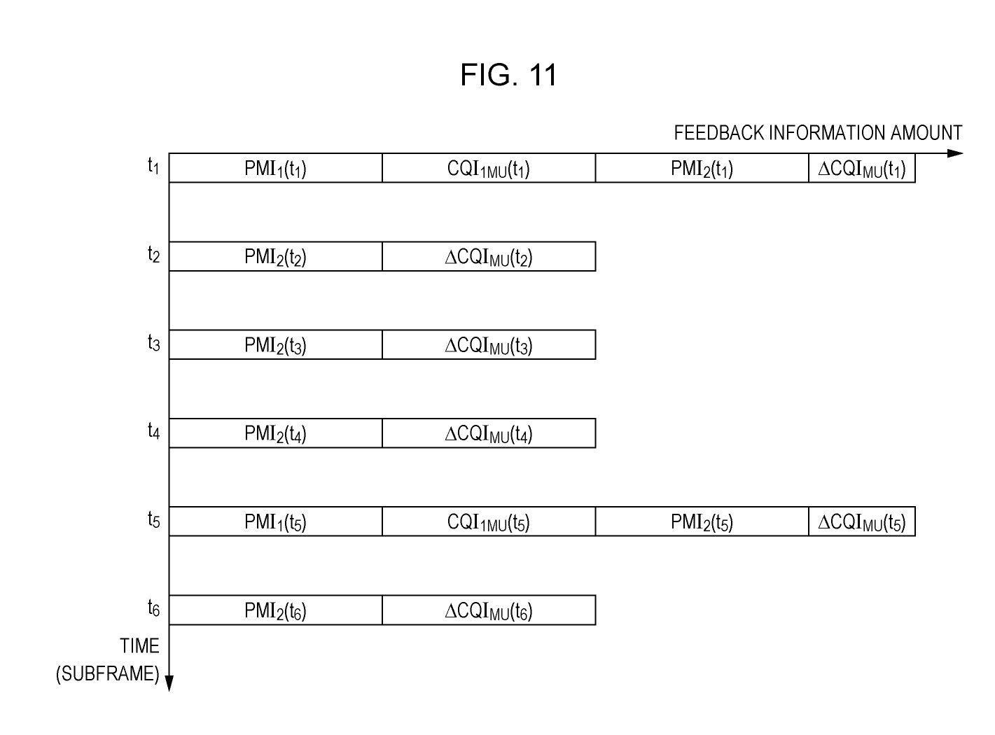

FIG. 11 is a diagram illustrating an example of feedback information that is transmitted and received between the base station device 200 and the terminal device 300 according to the present embodiment.

In FIG. 11, times t₁ to t₆ represent feedback timings when feedback from the terminal device 300 is performed, times t₁ and is are first feedback timings, and times t₂, t₃, t₄ and t₆ are second feedback timings. Further, PMI₁(t), PMI₂(t), CQI_{1MU}(t) and ΔCQI_{MU}(t) represent PMI₁, PMI₂, CQI_{1MU} and ΔCQI_{MU} at respective times t.

At the time t₁ which is the first feedback timing, the terminal device 300 selects the first pre-coding matrix W₁ and the second pre-coding matrix W₂, and notifies the base station device 200 of the PMI₁(t₁) and PMI₂(t₁) which respectively correspond thereto, CQI_{1MU}(t₁) representing the partial MU-CQI, and ΔCQI_{MU}(t₁) indicating a difference value between the entire MU-CQI and the partial MU-CQI. The base station device 200 calculates (restores) CQI_{1MU}(t₁)+ΔCQI_{MU}(t₁) as a value of the entire MU-CQI which is fed back at the time t₁.

At the time t₂ which is the second feedback timing, assuming that the first pre-coding matrix W₁ corresponding to PMI₁(t₁) which is PMI₁ that has most recently been notified to the base station device 200 is used as it is, the terminal device 300 reselects the second pre-coding matrix W₂, notifies the base station device 200 of PMI₂(t₂) indicating the number, calculates CQI_{MU}(t₂) indicating the entire MU-CQI based on the desired pre-coding matrix WFB which is indicated by PMI₁(t₁) and PMI₂(t₂), obtains ΔCQI_{MU}(t₂) from a difference value between CQI_{MU}(t₂) and CQI_{1MU}(t₁), and notifies the base station device 200 of the obtained ΔCQI_{MU}(t₂). The base station device 200 calculates (restores) CQI_{1MU}(t₁)+ΔCQI_{MU}(t₂) as a value of the entire MU-CQI which is fed back at the time t₂.

Also at the time t₃ which is the second feedback timing, similarly to the time t₂, assuming that the first pre-coding matrix W₁ corresponding to PMI₁(t₁) which is PMI₁ that has most recently been notified to the base station device 200 is used as it is, the terminal device 300 reselects the second pre-coding matrix W₂, notifies the base station device 200 of PMI₂(t₃) indicating the number, calculates CQI_{MU}(t₃) indicating the entire MU-CQI based on the desired pre-coding matrix WFB which is indicated by PMI₁(t₁) and PMI₂(t₃), obtains ΔCQI_{MU}(t₃) from a difference value between CQI_{MU}(t₃) and CQI_{1MU}(t₁), and notifies the base station device 200 of the obtained ΔCQI_{MU}(t₃). The base station device 200 calculates CQI_{1MU}(t₁)+ΔCQI_{MU}(t₃) as a value of MU-CQI which is fed back at the time t₃. Feedback is also performed similarly at the time t₄.

At the time is which is the first feedback timing, similarly to the time t₁, the terminal device 300 selects the first pre-coding matrix W₁ and the second pre-coding matrix W₂, and notifies the base station device 200 of the PMI₁(t₅) and PMI₂(t₅) which respectively correspond thereto, CQI_{1MU}(t₅) representing the partial MU-CQI, and ΔCQI_{MU}(t₅) indicating a difference value between the entire MU-CQI and the partial MU-CQI. The base station device 200 calculates (restores) CQI_{1MU}(t₅)+ΔCQI_{MU}(t₅) as a value of the entire MU-CQI which is fed back at the time t₅.

Also at the time t₆ which is the second feedback timing, similarly to the times t₂, t₃ and t₄, assuming that the first pre-coding matrix W₁ corresponding to PMI₁(t₅) which is PMI₁ that has most recently been notified to the base station device 200 is used as it is, the terminal device 300 reselects the second pre-coding matrix W₂, notifies the base station device 200 of PMI₂(t₆) indicating the number, calculates CQI_{MU}(t₆) indicating the entire MU-CQI based on the desired pre-coding matrix WFB which is indicated by PMI₁(t₅) and PMI₂(t₆), obtains ΔCQI_{MU}(t₆) from a difference value between CQI_{MU}(t₆) and CQI_{1MU}(t₅), and notifies the base station device 200 of the obtained ΔCQI_{MU}(t₆). The base station device 200 calculates (restores) CQI_{1MU}(t₅)+ΔCQI_{MU}(t₆) as a value of the entire MU-CQI which is fed back at the time t₆. Hereinafter, a feedback process is performed similarly.

As described above, in the present embodiment, when the terminal device 300 feeds back the information on the desired pre-coding matrix to the base station device 200, in the case of notifying PMI₁ and PMI₂ indicating the numbers of the first pre-coding matrix W₁ and the second pre-coding matrix W₂, the CQI_{1MU} indicating the partial MU-CQI and ΔCQI_{MU} indicating a difference value between the MU-CQI and the partial MU-CQI is notified, and in the case of notifying only PMI₂, ΔCQI_{MU} indicating a difference value between the entire MU-CQI and CQI_{1MU} that is the partial MU-CQI which has most recently been notified, is notified. In other words, in the present embodiment, the terminal device 300 simultaneously notifies of the CQI_{1MU} indicating the partial MU-CQI at the first feedback timing when the information PMI₁ on the first pre-coding matrix W₁ is fed back, simultaneously notifies of ΔCQI_{MU} indicating a difference value between the entire MU-CQI and MU-CQI corresponding to CQI_{1MU} which has most recently been notified at the second feedback timing when the information PMI₂ on the second pre-coding matrix W₂ is fed back, and simultaneously notifies of the CQI_{1MU} and ΔCQI_{MU}, when timings when PMI₁ and PMI₂ are fed back match each other.

Therefore, the base station device 200 can select proper modulation scheme and coding rate for transmission data addressed to each terminal device 300 based on the channel quality MU-CQI during the MU-MIMO transmission, and improve a throughput performance in the base station device 200, and the terminal device 300 can reduce the amount of information required for feedback of the MU-CQI. Further, it is possible to reduce the available range of the difference value, and further reduce the feedback information amount by using a difference value from the partial MU-CQI that has most recently been notified, as the notified difference value.

### Third Embodiment

The schematic configuration example of a radio communication system of the present embodiment is illustrated in FIG. 1, similarly to the first embodiment. Further, the configuration of the base station device 200 is similar to FIG. 2, and the process of the feedback information obtaining unit 206 is different from the first embodiment. The configuration of the terminal device 300 is similar to FIG. 3, and the processes of the pre-coding matrix selection unit 304, the channel quality calculation unit 305 and the feedback information generation unit 306 are different from the first embodiment. In the following, with respect to the radio communication system of the present embodiment, components different from the first embodiment will be described and components similar to the first embodiment will not be described.

In the present embodiment, the terminal device 300 selects only the first pre-coding matrix W₁ and assumes it as the desired pre-coding matrix W_{FB}, at the first feedback timing. The terminal device 300 calculates the MU-CQI (the partial MU-CQI) in the case of assuming that the base station device 200 combines the terminal device 300 with another terminal device by performing pre-coding by using the desired pre-coding matrix W_{FB} (=W₁) and performs MU-MIMO transmission. In addition, at this time, assuming the case of using the most recently selected second pre-coding matrix W₂, the terminal device 300 may reselect only a new first pre-coding matrix W₁ and calculate MU-CQI, with a combination of the newly selected first pre-coding matrix W₁ and the most recently selected second pre-coding matrix W₂ as the desired pre-coding matrix W_{FB} (=W₁W₂).

Further, similarly to the first embodiment, the terminal device 300 selects only the second pre-coding matrix W₂, based on the estimation result of the channel state on the same basis, under a condition in which the first pre-coding matrix W₁ selected at the most recent first feedback timing is used as it is, at the second feedback timing, and selects a new desired pre-coding matrix WFB.

The terminal device 300 notifies the base station device 200 of PMI₁ indicating the number of the selected first pre-coding matrix W₁ and CQI_{1MU} which is the number indicating partial MU-CQI at the first feedback timing, and notifies the base station device 200 of PMI₂ indicating the number of the selected second pre-coding matrix W₂, and ΔCQI_{MU} which is the number indicating a difference value between the calculated MU-CQI and the partial MU-CQI which has been notified at the most recent first feedback timing, at the second feedback timing. Further, the terminal device 300 may notify the base station device 200 of information (RI) regarding the number of ranks of MIMO.

The base station device 200 obtains the feedback information PMI₁ and CQI_{1MU}, or PMI₂ and ΔCQI_{MU} which have been notified from each terminal device 300, and performs pre-coding on the transmission data addressed to each terminal device 300 based on the information. Further, prior to the pre-coding, it is preferable to perform adaptive modulation for determining a modulation scheme and a coding rate on the transmission data addressed to each terminal device 300, based on the partial MU-CQI that is indicated by CQI_{1MU} that has been notified from each terminal device 300 at the first feedback timing, and the MU-CQI that is indicated by the addition result of CQI_{1MU} and ΔCQI_{MU} that have been notified from each terminal device 300 at the second feedback timing. The base station device 200 spatially multiplexes the transmission data subjected to the pre-coding into the same radio resource and transmits it.

In FIG. 3, the pre-coding matrix selection unit 304 according to the terminal device 300 of the present embodiment selects the first pre-coding matrix W₁ selected from the first codebook, based on the channel state estimation result of the channel estimation unit 303, as the desired pre-coding matrix WFB, at the first feedback timing.

Further, the pre-coding matrix selection unit 304 selects only the second pre-coding matrix W₂, based on the estimation result of the channel state of the channel estimation unit 303 on the same basis as Expression (1), under a condition of using the first pre-coding matrix W₁ as it is which has most recently been selected and stored in the feedback information storage unit 307, at the second feedback timing, and selects a new desired pre-coding matrix W_{FB}.

The channel quality calculation unit 305 according to the terminal device 300 of the present embodiment, at the first feedback timing, calculates the desired pre-coding matrix WFB selected by the pre-coding matrix selection unit 304, in other words, the partial MU-CQI in the case of assuming that the base station device 200 performs pre-coding by using the first pre-coding matrix W₁ and performs MU-MIMO transmission, and at the second feedback timing, calculates the MU-CQI in the case of assuming that the base station device 200 performs pre-coding by using the desired pre-coding matrix WFB selected by the pre-coding matrix selection unit 304, in other words, a product of the first pre-coding matrix W₁ selected at the most recent first feedback timing and the newly selected second pre-coding matrix W₂, and performs MU-MIMO transmission.

The feedback information generation unit 306 according to the terminal device 300 of the present embodiment, at the first feedback timing, generates feedback information PMI₁ indicating the number of the first pre-coding matrix W₁ constituting the desired pre-coding matrix WFB selected by the pre-coding matrix selection unit 304, and generates feedback information CQI_{1MU} indicating the partial MU-CQI calculated by the channel quality calculation unit 305.

Further, the feedback information generation unit 306 generates PMI₂ indicating the number of the second pre-coding matrix W₂ which is reselected, and ΔCQI_{MU} which is the number indicating a difference value between the calculated MU-CQI and the partial MU-CQI which is stored in the feedback information storage unit 307 and is notified at the most recent first feedback timing, at the second feedback timing. In addition, the details of the generation of the feedback information will be described later.

The feedback information storage unit 307 stores feedback information that is generated by the feedback information generation unit 306. In addition, in the present embodiment, it is sufficient to store PMI₁ and CQI_{1MU}.

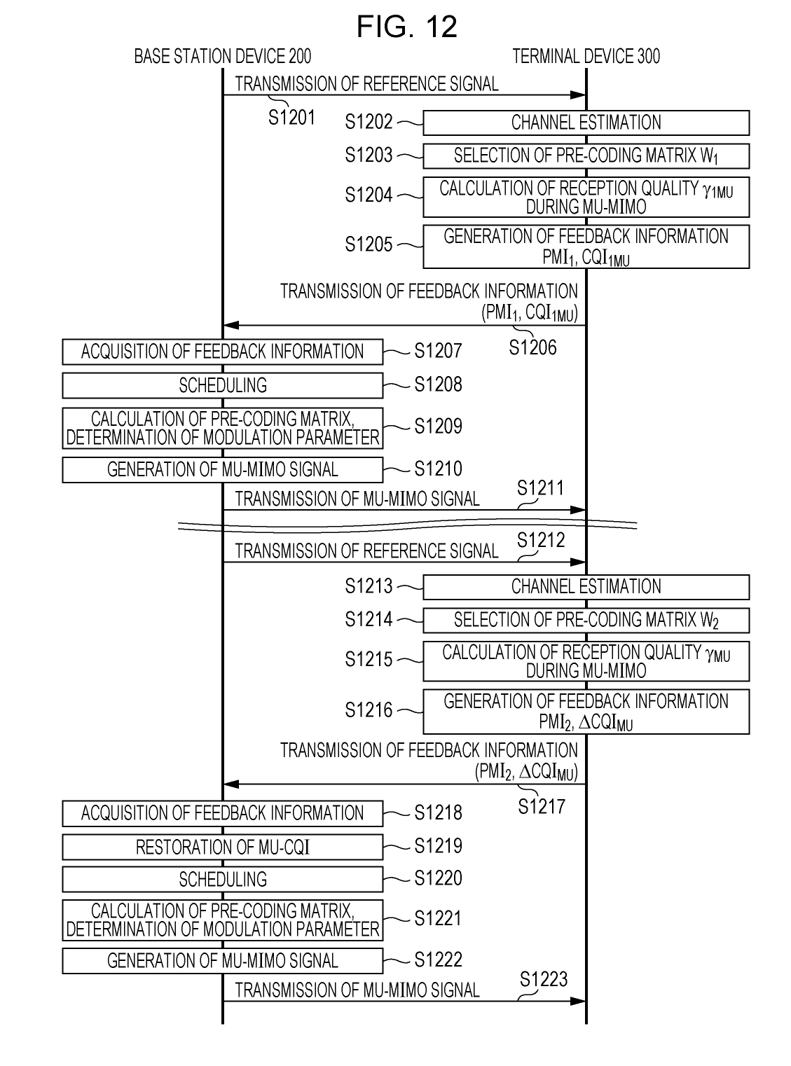

FIG. 12 is a sequence chart illustrating an example of transmission and reception of feedback information between the base station device 200 and the terminal device 300 according to the present embodiment.

First, the base station device 200 transmits reference signals such as CRS and CSI-RS to the terminal device 300 (step S1201).

The terminal device 300 receives the reference signal that the base station device 200 has transmitted, and estimates the channel state between each antenna of the base station device 200 and each antenna of the terminal device, based on the received reference signal (step S1202).

Here, assuming the case at the first feedback timing, the terminal device 300 selects the desired pre-coding matrix WFB by selecting the first pre-coding matrix W₁ from the first codebook, based on the estimation result of the channel state (step S1203).

Further, the terminal device 300 calculates the partial MU-CQI value γ_{1MU}, using Expression (2) and the like, based on the estimation result of the channel state and the desired pre-coding matrix W_{FB}(=W₁) selected in step S1203 (step S1204).

The terminal device 300 generates feedback information PMI₁ indicating the number of the first pre-coding W₁ selected in step S1203, and feedback information CQI_{1MU} indicating partial MU-CQI calculated in step S1204 (step S1205). For example, the terminal device 300 selects the combination that can satisfy a required block error rate, a required packet error rate, a required frame error rate, or the like when the SINR is γ_{1MU}, based on γ_{1MU} calculated in step S1204, from a table of combinations of the modulation scheme and the coding rate as illustrated in FIG. 5, and generates the number as feedback information CQI_{1MU} indicating the partial MU-CQI. For example, in FIG. 5, when the SINR is γ_{1MU}, the terminal device 300 generates CQI_{1MU}=7 when a combination capable of realizing a maximum transmission speed is a combination of the modulation scheme 16 QAM and the coding rate 1/3, among combinations of the modulation scheme and the coding rate which satisfy the required block error rate 0.1. In addition, the value obtained by quantizing γ_{1MU} which is the value of the calculated SINR as it is may be used as the CQI_{1MU}.

The terminal device 300 transmits the PMI₁ and CQI_{1MU} on the feedback information, which are generated in step S1205, to the base station device 200 (step S1206).

The base station device 200 receives the signal that the terminal device 300 has transmitted, and obtains the feedback information PMI₁ and CQI_{1MU} (step S1207). Further, the base station device 200 obtains the desired pre-coding matrix W_{FB} of the terminal device 300, from the obtained PMI₁.

The base station device 200 performs scheduling, based on the desired pre-coding matrix W_{FB} of each terminal device 300, each corresponding MU-CQI (CQI_{1MU} or CQI_{MU}=CQI_{1MU}+ΔCQI_{MU} at a feedback timing of each terminal device 300), and the accumulated amount, the priority, the allowable delay time, and the like of the transmission data addressed to each terminal device 300, and selects a plurality of terminal devices 300 which are to be subjected to the MU-MIMO transmission among them (step S1208).

The base station device 200 calculates a pre-coding matrix W_{TX} based on a plurality of desired pre-coding matrices WFB respectively corresponding to a plurality of terminal devices 300 which are selected as MU-MIMO transmission targets, and determines a modulation scheme and a coding rate for transmission data of each terminal device 300 based on each similarly corresponding MU-CQIs (CQI_{1MU} or CQI_{MU}) (step S1209).

The base station device 200 generates a MU-MIMO signal by performing error correction coding, rate matching, and modulation on the transmission data addressed to each terminal device 300, based on the coding rate and the modulation scheme that are determined in step S1209, and by performing pre-coding by multiplying the transmission data by the calculated pre-coding matrix W_{TX} (step S1210), and transmits the generated MU-MIMO signal to each terminal device 300 (step S1211).

Next, the base station device 200 transmits again the reference signal such as the CRS and CSI-RS to the terminal device 300 (step S1212).

The terminal device 300 receives the reference signal that the base station device 200 has transmitted, and estimates the channel state between each antenna of the base station device 200 and each antenna of the terminal device, based on the received reference signal (step S1213).

Here, assuming the case at the second feedback timing, the terminal device 300 selects the desired pre-coding matrix W_{FB} by reselecting only the second pre-coding matrix W₂ from the second codebook, based on the estimation result of the channel state, assuming that the pre-coding matrix W₁ corresponding to PMI₁ that has been notified in step S1206 (the first pre-coding matrix which has most recently been notified to the base station device 200) is used as it is as the first pre-coding matrix W₁ (step S1214).

The terminal device 300 calculates the value γ_{MU} of MU-CQI by using Expression (2), based on the estimation result of the channel state and the desired pre-coding matrix W_{FB} selected in step S1214 (step S1215).

The terminal device 300 generates feedback information PMI₂ indicating the number of the second pre-coding matrix W₂ selected in step S1214, obtains feedback information CQI_{MU} indicating the MU-CQI based on γ_{MU} calculated in step S1215, calculates a difference value (partial MU-CQI that has most recently been notified to the base station device 200) with the CQI_{1MU} which is generated in step S1205, and generates feedback information ΔCQI_{MU} indicating the MU-CQI difference value (step S1216). In addition, it is preferable that the ΔCQI_{MU} is generated based on, for example, a table of the MU-CQI difference value and ΔCQI_{MU} illustrated in FIG. 9 and FIG. 10, but may be generated based on a method capable of realizing the ΔCQI_{MU} with an information amount (the number of bits) less than the CQI_{1MU}, without being limited thereto.

The terminal device 300 transmits the feedback information PMI₂ and ΔCQI_{MU} which are generated in step S1216, to the base station device 200 (step S1217).

The base station device 200 receives the signal that the terminal device 300 has transmitted, and obtains the feedback information PMI₂ and ΔCQI_{MU} (step S1218). Further, the base station device 200 obtains the desired pre-coding matrix WFB of the terminal device 300, from the obtained PMI₂, and PMI₁ which has most recently been notified from the terminal device 300.

The base station device 200 restores MU-CQI (CQI_{MU} in the feedback at the present) by adding ΔCQI_{MU} that is obtained in step S1218 and the CQI_{1MU} that has most recently been notified from the terminal device 300 (step S1219).

The base station device 200 performs scheduling, based on the desired pre-coding matrix WFB of each terminal device 300, each corresponding MU-CQI that is restored in step S1219, and the accumulated amount, the priority, the allowable delay time, and the like of the transmission data addressed to each terminal device 300, and selects a plurality of terminal devices 300 which are to be subjected to the MU-MIMO transmission among them (step S1220).

The base station device 200 calculates a pre-coding matrix W_{TX} based on a plurality of desired pre-coding matrices W_{FB} respectively corresponding to a plurality of terminal devices 300 which are selected as MU-MIMO transmission targets, and determines a modulation scheme and a coding rate for transmission data of each terminal device 300 based on each similarly corresponding MU-CQI that is restored in step S1219 (step S1221).

The base station device 200 generates a MU-MIMO signal by performing error correction coding, rate matching, and modulation on the transmission data addressed to each terminal device 300, based on the coding rate and the modulation scheme that are determined in step S1221, and by performing pre-coding by multiplying the transmission data by the calculated pre-coding matrix W_{TX} (step S1222), and transmits the generated MU-MIMO signal to each terminal device 300 (step S1223).

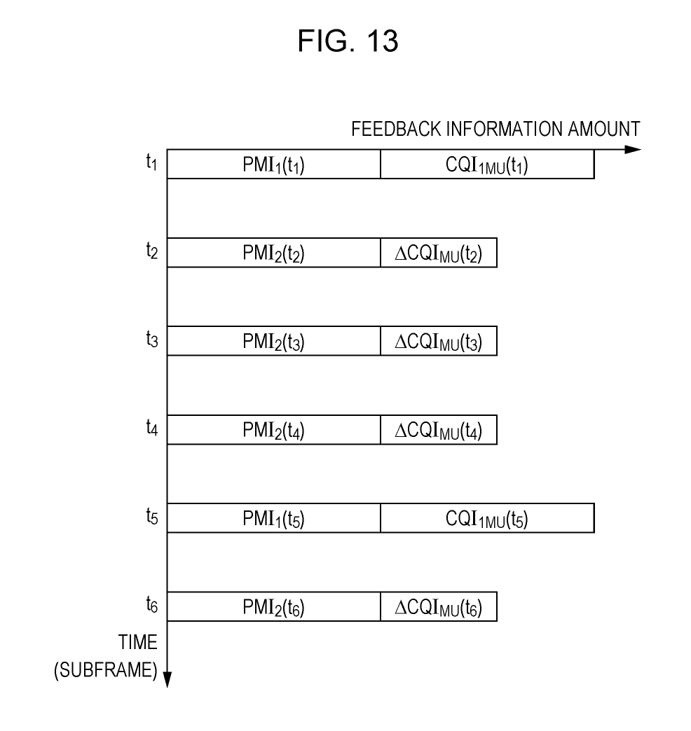

FIG. 13 is a diagram illustrating an example of feedback information that is transmitted and received between the base station device 200 and the terminal device 300 according to the present embodiment.

In FIG. 13, times t₁ to t₆ represent feedback timings when feedback from the terminal device 300 is performed, times t₁ and t₅ is are first feedback timings, and times t₂, t₃, t₄ and t₆ are second feedback timings. Further, PMI₁(t), PMI₂(t), CQI_{1MU}(t) and ΔCQI_{MU}(t) represent PMI₁, PMI₂, CQI_{1MU} and ΔCQI_{MU} at respective times t.

At the time t₁ which is the first feedback timing, the terminal device 300 selects the first pre-coding matrix W₁, and notifies the base station device 200 of the PMI₁(t₁) correspond thereto, and CQI_{1MU}(t₁) representing the partial MU-CQI. The base station device 200 calculates (restores) CQI_{1MU}(t₁) as a value of the MU-CQI which is fed back at the time t₁.

At the time t₂ which is the second feedback timing, assuming that the first pre-coding matrix W₁ corresponding to PMI₁(t₁) which is PMI₁ that has been notified to the base station device 200 most recently is used as it is, the terminal device 300 reselects the second pre-coding matrix W₂, notifies the base station device 200 of PMI₂(t₂) indicating the number, calculates CQI_{MU}(t₂) indicating the MU-CQI based on the desired pre-coding matrix WFB which is indicated by PMI₁(t₁) and PMI₂(t₂), obtains ΔCQI_{MU}(t₂) from a difference value between CQI_{MU}(t₂) and CQI_{1MU}(t₁), and notifies the base station device 200 of the obtained the ΔCQI_{MU}(t₂). The base station device 200 calculates (restores) CQI_{1MU}(t₁)+ΔCQI_{MU}(t₂) as a value of the MU-CQI which is fed back at the time t₂.

Also at the time t₃ which is the second feedback timing, similarly to the time t₂, assuming that the first pre-coding matrix W₁ corresponding to PMI₁(t₁) which is PMI₁ that has been notified to the base station device 200 most recently is used as it is, the terminal device 300 reselects the second pre-coding matrix W₂, notifies the base station device 200 of PMI₂(t₃) indicating the number, calculates CQI_{MU}(t₃) indicating the MU-CQI based on the desired pre-coding matrix WFB which is indicated by PMI₁(t₁) and PMI₂(t₃), obtains ΔCQI_{MU}(t₃) from a difference value between CQI_{MU}(t₃) and CQI_{1MU}(t₁), and notifies the base station device 200 of the obtained ΔCQI_{MU}(t₃). The base station device 200 calculates CQI_{1MU}(t₁)+ΔCQI_{MU}(t₃) as a value of MU-CQI which is fed back at the time t₃. Feedback is also performed similarly at the time t₄.

At the time is which is the first feedback timing, similarly to the time t₁, the terminal device 300 selects the first pre-coding matrix W₁, and notifies the base station device 200 of the corresponding PMI₁(t₅), and CQI_{1MU}(t₅) representing the partial MU-CQI. The base station device 200 calculates (restores) CQI_{1MU}(t₅) as a value of the MU-CQI which is fed back at the time t₅.

Also at the time t₆ which is the second feedback timing, similarly to the times t₂, t₃, t₄, assuming that the first pre-coding matrix W₁ corresponding to PMI₂(t₅) which is PMI₁ that has been notified to the base station device 200 most recently is used as it is, the terminal device 300 reselects the second pre-coding matrix W₂, notifies the base station device 200 of PMI₂(t₆) indicating the number, calculates CQI_{MU}(t₆) indicating the MU-CQI based on the desired pre-coding matrix WFB which is indicated by PMI₁(t₅) and PMI₂(t₆), obtains ΔCQI_{MU}(t₆) from a difference value between CQI_{MU}(t₆) and CQI_{1MU}(t₅), and notifies the base station device 200 of the obtained ΔCQI_{MU}(t₆). The base station device 200 calculates (restores) CQI_{1MU}(t₅)+ΔCQI_{MU} (t₆) as a value of the MU-CQI which is fed back at the time t₆. Hereinafter, a feedback process is performed similarly.

As described above, in the present embodiment, when the terminal device 300 feeds back the information on the desired pre-coding matrix to the base station device 200, in the case of notifying PMI₁ indicating the number of the first pre-coding matrix W₁, the CQI_{1MU} indicating the partial MU-CQI is notified, and in the case of notifying only PMI₂ indicating the number of the second pre-coding matrix W₂, ΔCQI_{MU} indicating a difference value from the CQI_{1MU} that is the partial MU-CQI which has most recently been notified, is notified. In other words, in the present embodiment, the terminal device 300 simultaneously notifies of the CQI_{1MU} indicating the partial MU-CQI at the first feedback timing when the information PMI₁ on the first pre-coding matrix W₁ is fed back, simultaneously notifies of ΔCQI_{MU} indicating a difference value between the entire MU-CQI and the partial MU-CQI corresponding to CQI_{1MU} which has most recently been notified at the second feedback timing when the information PMI₂ on the second pre-coding matrix W₂ is fed back, and the notification of the PMI₂ and ΔCQI_{MU} is cancelled when the feedback timings of PMI₁ and PMI₂ match each other.

Therefore, the base station device 200 can select proper modulation scheme and coding rate for transmission data addressed to each terminal device 300 based on the channel quality MU-CQI during the MU-MIMO transmission, and improve a throughput performance in the base station device 200, and the terminal device 300 can reduce the amount of information required for feedback of the MU-CQI. Further, it is possible to reduce the available range of the difference value, and further reduce the feedback information amount by using a difference value from the partial MU-CQI that has been notified most recently as the notified difference value. Further, it is possible to further reduce the feedback information amount by notifying only PMI₁ at the first feedback timing.

In the above respective embodiments, the case of using the CQI_{MU} or the CQI_{1MU}, and the ΔCQI_{MU} indicating a difference value from the most recent CQI_{MU} or the CQI_{1MU} in the feedback of the channel quality MU-CQI during the MU-MIMO transmission has been described, but feedback information (ΔCQI_{MU-SU}) may be generated based on a difference value (CQI_{MU}−CQI_{SU} or CQI_{1MU}−CQI_{SU}) from the channel quality SU-CQI (CQI_{SU}) during the SU-MIMO transmission, instead of the CQI_{MU} or the CQI_{1MU}, and information indicating a difference value from the CQI_{SU}+ΔCQI_{MU-SU} may be generated for the ΔCQI_{MU}.

Further, in the above respective embodiments, the case where the first pre-coding matrix W₁ and the second pre-coding matrix W₂ are respectively selected from all candidates for the pre-coding matrix in the first codebook and the second codebook has been described, but without being limited thereto, for example, since the candidates for the pre-coding matrix that can be selected by the terminal device 300 have been narrowed down for the first codebook or the second codebook or both codebooks, in response to an instruction (such as a control message) from the base station device 200, the desired pre-coding matrix WFB may be selected on the above standard.

Hitherto, the embodiments of the present invention have been described in detail with reference to the drawings, but the specific configuration is not limited to this embodiment, and a design change within the scope without departing from the gist of the present invention is included in the claims.

In addition, the present invention is not intended to be limited to the above-described embodiment. The terminal device 300 of the present invention is not limited to be applied to the terminal device, such as a cellular system and a radio LAN system, and it is needless to say that the terminal device 300 can be applied to stationary type or non-movable type electronic devices that are installed indoors or outdoors, for example, AV equipment, kitchen equipment, cleaning and washing equipment, air-conditioning equipment, office equipment, vending machines, and other life equipment.

The programs operating in the base station device 200 and the terminal device 300 according to the present invention are programs controlling the CPU or the like (programs for causing a computer to function) so as to realize the functions of the above embodiments according to the present invention. Then, information handled by these devices is temporarily stored in the RAM during the process, then is stored in various ROMs or HDDs, and is read by the CPU if necessary so as to be modified and written. A recording media storing programs may be any of a semiconductor medium (for example, a ROM, a nonvolatile memory card, and the like), an optical recording media (for example, a DVD, a MO, a MD, a CD, a BD, and the like), a magnetic recording medium (for example, a magnetic tape, a flexible disk or the like). Further, the functions of the embodiment mentioned above are realized not only by executing the loaded program, but also by processing in cooperation with an operating system or another application program or the like on the basis of instructions of the program.

In the case of distributing the programs on the market, the programs can be distributed by being stored in the portable storage medium, or by being transferred to a server computer connected through a network such as the Internet. In this case, the storage device of the server computer is also included in the present invention. Further, some or all of the base station device 200 and the terminal device 300 in the above-described embodiments may be implemented typically by integrated circuits LSIs. The functional blocks of the base station device 200 and the terminal device 300 may be individually formed into processors, or some or all thereof may be integrated and formed into processors. Further, an integration method is not limited to LSI, and may be realized by a dedicated circuit or a general-purpose processor. Further, when an integration technique substituting LSI appears by advances in a semiconductor technique, it is also possible to use an integrated circuit by the technique.

### SUMMARY

Herein, at least the following invention has also been described.

(1) In order to achieve the object described above, the present invention devises the following means. That is, a feedback information notification method according to the present invention selects a first pre-coding matrix from a first codebook including at least one pre-coding matrix candidate, and notifies of first pre-coding matrix information indicating the selected first pre-coding matrix, and channel quality information indicating a channel quality during multi-user MIMO transmission, at a first feedback timing, and selects a second pre-coding matrix from a second codebook including at least one pre-coding matrix candidate, and notifies of second pre-coding matrix information indicating the selected second pre-coding matrix, and differential channel quality information based on a difference value between a channel quality during the multi-user MIMO transmission and a channel quality indicated by the channel quality information of which notification is most recently sent, at a second feedback timing.

(2) In the feedback information notification method according to the present invention, when the first feedback timing and the second feedback timing match each other, notifications of the first pre-coding matrix information, the second pre-coding matrix information, and the channel quality information are sent, and the channel quality information indicates a channel quality during the multi-user MIMO transmission, which is calculated based on the selected first pre-coding matrix and the selected second pre-coding matrix.

(3) In the feedback information notification method according to the present invention, the differential channel quality information indicates a difference value between the channel quality indicated by the channel quality information of which notification is most recently sent, and a channel quality during the multi-user MIMO transmission that is calculated based on the first pre-coding matrix indicated by the first pre-coding matrix information of which notification is most recently sent and the selected second pre-coding matrix.

(4) In the feedback information notification method according to the present invention, when the first feedback timing and the second feedback timing match each other, notifications of the first pre-coding matrix information, the second pre-coding matrix information, the channel quality information, and the differential channel quality information are sent, the channel quality information indicates a channel quality during the multi-user MIMO transmission, which is calculated based on the selected first pre-coding matrix, and the differential channel quality information indicates a difference value between a channel quality during the multi-user MIMO transmission which is calculated based on the selected first pre-coding matrix and the selected second pre-coding matrix, and a channel quality which is indicated by the channel quality information.

(5) In the feedback information notification method according to the present invention, the channel quality information indicates a channel quality during the multi-user MIMO transmission, which is calculated based on the selected first pre-coding matrix, and the differential channel quality information indicates a difference value between a channel quality during the multi-user MIMO transmission that is calculated based on a first pre-coding matrix indicated by the first pre-coding matrix information of which notification is most recently sent and the selected second pre-coding matrix, and a channel quality indicated by the channel quality information of which notification is most recently sent.

(6) A terminal device according to the present invention includes a channel estimation unit that estimates a channel state between each antenna of the base station device and at least one antenna of the terminal device; a pre-coding matrix selection unit that selects a first pre-coding matrix from a first codebook including at least one pre-coding matrix candidate based on the estimation result of the channel state, at a first feedback timing, and selects a second pre-coding matrix from a second codebook including at least one pre-coding matrix candidate, based on the estimation result of the channel state and the most recently selected first pre-coding matrix, at a second feedback timing; a channel quality calculation unit that calculates a channel quality during the multi-user MIMO transmission based on the selected first pre-coding matrix and the estimation result of the channel state at the first feedback timing, and calculates the channel quality during the multi-user MIMO transmission based on the most recently selected first pre-coding matrix, the selected second pre-coding matrix, and the estimation result of the channel state, at the second feedback timing; and a feedback information generation unit that generates first pre-coding matrix information indicating the selected first pre-coding matrix and channel quality information indicating the calculated channel quality during the multi-user MIMO transmission, as feedback information, at the first feedback timing, and generates second pre-coding matrix information indicating the selected second pre-coding matrix, and differential channel quality information based on a difference value between the calculated channel quality during the multi-user MIMO transmission and a channel quality indicated by the channel quality information of which notification is most recently sent, at a second feedback timing.

(7) In the terminal device according to the present invention, when the first feedback timing and the second feedback timing match each other, the pre-coding matrix selection unit selects a first pre-coding matrix from the first codebook and selects a second pre-coding matrix from the second codebook, respectively, the channel quality calculation unit calculates a channel quality during the multi-user MIMO transmission, based on the selected first pre-coding matrix, the selected second pre-coding matrix, and the estimation result of the channel state, and the feedback information generation unit generates first pre-coding matrix information indicating the selected first pre-coding matrix, second pre-coding matrix information indicating the selected second pre-coding matrix, and channel quality information indicating the calculated channel quality during the multi-user MIMO transmission, as feedback information.

(8) In the terminal device according to the present invention, when the first feedback timing and the second feedback timing match each other, the pre-coding matrix selection unit selects a first pre-coding matrix from the first codebook and selects a second pre-coding matrix from the second codebook, respectively, the channel quality calculation unit calculates a first channel quality during the multi-user MIMO transmission, based on the selected first pre-coding matrix and the estimation result of the channel state, and calculates a second channel quality during the multi-user MIMO transmission, based on the selected first pre-coding matrix, the selected second pre-coding matrix, and the estimation result of the channel state, and the feedback information generation unit generates first pre-coding matrix information indicating the selected first pre-coding matrix, second pre-coding matrix information indicating the selected second pre-coding matrix, channel quality information indicating the first channel quality, and differential channel quality information indicating a differential value between the second channel quality and the first channel quality, as feedback information.

(9) In the terminal device according to the present invention, when the first feedback timing and the second feedback timing match each other, the terminal device performs a process relating to the first feedback timing.

(10) A base station device according to the present invention includes a feedback information obtaining unit that obtains either one or both of first pre-coding matrix information indicating a first pre-coding matrix which is selected from a first codebook including at least one pre-coding matrix candidate, and second pre-coding matrix information indicating a second pre-coding matrix which is selected from a second codebook including at least one pre-coding matrix candidate, of which notifications are sent from the plurality of terminal devices, obtains either one or both of channel quality information indicating a channel quality during the multi-user MIMO transmission, and differential channel quality information based on a difference value from a channel quality indicated by the channel quality information, and calculates a desired pre-coding matrix which is selected by each of the plurality of terminal devices and a channel quality during the multi-user MIMO transmission; and a pre-coding matrix calculation unit that calculates a pre-coding matrix which is used for pre-coding of transmission data addressed to the plurality of terminal devices, based on the calculated desired pre-coding matrix for each terminal device and the calculated channel quality during the multi-user MIMO transmission, and determines a modulation scheme and a coding rate for the transmission data addressed to the plurality of terminal devices.

(11) In the base station device according to the present invention, when the differential channel quality information is obtained from the terminal device, the feedback information obtaining unit calculates a result obtained by adding a channel quality indicated by channel quality information of which notification is most recently sent from the terminal device to a differential value from a channel quality indicated by the differential channel quality information, as channel quality during the multi-user MIMO transmission of the terminal device.

(12) In the base station device according to the present invention, when notifications of the channel quality information and the differential channel quality information are sent at the same timing from a terminal device, the feedback information obtaining unit calculates a result obtained by adding a channel quality indicated by the channel quality information to a differential value from a channel quality indicated by the differential channel quality information, as channel quality during the multi-user MIMO transmission of the terminal device.

(13) In a radio communication system according to the present invention, each terminal device selects a first pre-coding matrix from a first codebook including at least one pre-coding matrix candidate, and notifies the base station device of first pre-coding matrix information indicating the selected first pre-coding matrix, and channel quality information indicating a channel quality during multi-user MIMO transmission, at each first feedback timing, and selects a second pre-coding matrix from a second codebook including at least one pre-coding matrix candidate, and notifies the base station device of second pre-coding matrix information indicating the selected second pre-coding matrix, and differential channel quality information based on a difference value between a channel quality during the multi-user MIMO transmission and a channel quality indicated by the channel quality information of which notification is most recently sent, at each second feedback timing.

(14) An integrated circuit according to the present invention is an integrated circuit that is implemented in a terminal device and causes the terminal device to exert a plurality of functions of estimating a channel state between each antenna of the base station device and at least one antenna of the terminal device; selecting a first pre-coding matrix from a first codebook including at least one pre-coding matrix candidate based on the channel state, at a first feedback timing, and selecting a second pre-coding matrix from a second codebook including at least one pre-coding matrix candidate, based on the estimation result of the channel state and the most recently selected first pre-coding matrix, at a second feedback timing; calculating a channel quality during the multi-user MIMO transmission based on the selected first pre-coding matrix and the estimation result of the channel state at the first feedback timing, and calculating the channel quality during the multi-user MIMO transmission based on the most recently selected first pre-coding matrix, the selected second pre-coding matrix, and the estimation result of the channel state, at the second feedback timing; and generating first pre-coding matrix information indicating the selected first pre-coding matrix and channel quality information indicating the calculated channel quality during the multi-user MIMO transmission, as feedback information, at the first feedback timing, and generating second pre-coding matrix information indicating the selected second pre-coding matrix, and differential channel quality information based on a difference value between the calculated channel quality during the multi-user MIMO transmission and a channel quality indicated by the channel quality information of which notification is most recently sent, at the second feedback timing.

(15) An integrated circuit according to the present invention is an integrated circuit that is implemented in a base station device and causes the base station device to exert a plurality of functions of obtaining either one or both of first pre-coding matrix information indicating a first pre-coding matrix which is selected from a first codebook including at least one pre-coding matrix candidate, and second pre-coding matrix information indicating a second pre-coding matrix which is selected from a second codebook including at least one pre-coding matrix candidate, of which notifications are sent from the plurality of terminal devices, obtaining either one or both of channel quality information indicating a channel quality during the multi-user MIMO transmission, and differential channel quality information based on a difference value from a channel quality indicated by the channel quality information, and calculating a desired pre-coding matrix which is selected by each of the plurality of terminal devices and a channel quality during the multi-user MIMO transmission; and calculating a pre-coding matrix which is used for pre-coding of transmission data addressed to the plurality of terminal devices, based on the calculated desired pre-coding matrix for each terminal device and the calculated channel quality during the multi-user MIMO transmission, and determining a modulation scheme and a coding rate for the transmission data addressed to the plurality of terminal devices.

### INDUSTRIAL APPLICABILITY

The present invention is suitable to be used for a feedback information notification method, a terminal device, a base station device, and a radio communication system.

### REFERENCE SIGNS LIST

200 BASE STATION DEVICE
201 BASE STATION CONTROL UNIT
202 PRE-CODING MATRIX CALCULATION UNIT
203 DOWNLINK TRANSMISSION UNIT
204 ANTENNA UNIT
205 UPLINK RECEPTION UNIT
206 FEEDBACK INFORMATION OBTAINING UNIT
207 FEEDBACK INFORMATION STORAGE UNIT
300, 300-1 TO 300-4 TERMINAL DEVICE
301 ANTENNA UNIT
302 DOWNLINK RECEPTION UNIT
303 CHANNEL ESTIMATION UNIT
304 PRE-CODING MATRIX SELECTION UNIT
305 CHANNEL QUALITY CALCULATION UNIT
306 FEEDBACK INFORMATION GENERATION UNIT
307 FEEDBACK INFORMATION STORAGE UNIT
308 UPLINK TRANSMISSION UNIT

1: A feedback information notification method in which a terminal device notifies a base station device of feedback information for multi-user MIMO transmission, comprising:
selecting a first pre-coding matrix from a first codebook including at least one pre-coding matrix candidate, and notifying of first pre-coding matrix information indicating the selected first pre-coding matrix, and channel quality information indicating a channel quality during the multi-user MIMO transmission, at a first feedback timing; and
selecting a second pre-coding matrix from a second codebook including at least one pre-coding matrix candidate, and notifying of second pre-coding matrix information indicating the selected second pre-coding matrix, and channel quality information indicating a channel quality during the multi-user MIMO transmission, at a second feedback timing.

2: The feedback information notification method according to claim 1,
wherein the channel quality information of which notification is sent at the second feedback timing is second channel quality information, and the second channel quality information is differential channel quality information based on a difference value between the channel quality during the multi-user MIMO transmission and a channel quality indicated by first channel quality information which is the channel quality information of which notification is sent at the first feedback timing.

3: The feedback information notification method according to claim 1,
wherein when the first feedback timing and the second feedback timing match each other, notifications of the first pre-coding matrix information, the second pre-coding matrix information, and the channel quality information are sent, and
wherein the channel quality information indicates a channel quality during the multi-user MIMO transmission, which is calculated based on the selected first pre-coding matrix and the selected second pre-coding matrix.

4: The feedback information notification method according to claim 2,
wherein the differential channel quality information indicates a difference value between the channel quality indicated by the first channel quality information of which notification is most recently sent, and a channel quality during the multi-user MIMO transmission that is calculated based on the first pre-coding matrix indicated by the first pre-coding matrix information of which notification is most recently sent and the selected second pre-coding matrix.

5: The feedback information notification method according to claim 2,
wherein when the first feedback timing and the second feedback timing match each other, notifications of the first pre-coding matrix information, the second pre-coding matrix information, the first channel quality information, and the differential channel quality information are sent,
wherein the first channel quality information indicates a channel quality during the multi-user MIMO transmission, which is calculated based on the selected first pre-coding matrix, and
wherein the differential channel quality information indicates a difference value between a channel quality during the multi-user MIMO transmission which is calculated based on the selected first pre-coding matrix and the selected second pre-coding matrix, and a channel quality which is indicated by the first channel quality information.

6: The feedback information notification method according to claim 2,
wherein the first channel quality information indicates a channel quality during the multi-user MIMO transmission, which is calculated based on the selected first pre-coding matrix, and
wherein the differential channel quality information indicates a difference value between a channel quality during the multi-user MIMO transmission that is calculated based on a first pre-coding matrix indicated by the first pre-coding matrix information of which notification is most recently sent and the selected second pre-coding matrix, and a channel quality indicated by the first channel quality information of which notification is most recently sent.

7: A terminal device that performs communication with a base station device provided with a plurality of antennas, comprising:
a channel estimation unit that estimates a channel state between each antenna of the base station device and at least one antenna of the terminal device;
a pre-coding matrix selection unit that selects a first pre-coding matrix from a first codebook including at least one pre-coding matrix candidate based on the estimation result of the channel state, at a first feedback timing, and selects a second pre-coding matrix from a second codebook including at least one pre-coding matrix candidate, based on the estimation result of the channel state and the most recently selected first pre-coding matrix, at a second feedback timing;
a channel quality calculation unit that calculates a channel quality during the multi-user MIMO transmission based on the selected first pre-coding matrix and the estimation result of the channel state at the first feedback timing, and calculates the channel quality during the multi-user MIMO transmission based on the most recently selected first pre-coding matrix, the selected second pre-coding matrix, and the estimation result of the channel state, at the second feedback timing; and
a feedback information generation unit that generates first pre-coding matrix information indicating the selected first pre-coding matrix and channel quality information indicating the calculated channel quality during the multi-user MIMO transmission, as feedback information, at the first feedback timing, and generates second pre-coding matrix information indicating the selected second pre-coding matrix and channel quality information indicating the calculated channel quality during the multi-user MIMO transmission, at the second feedback timing.

8: The terminal device according to claim 7,
wherein the channel quality information generated at the second feedback timing is second channel quality information, and the second channel quality information is differential channel quality information based on a difference value between the calculated channel quality during the multi-user MIMO transmission and a channel quality indicated by first channel quality information which is the channel quality information of which notification is sent at the first feedback timing.

9: The terminal device according to claim 7,
wherein when the first feedback timing and the second feedback timing match each other,
the pre-coding matrix selection unit selects a first pre-coding matrix from the first codebook and selects a second pre-coding matrix from the second codebook, respectively,
the channel quality calculation unit calculates a channel quality during the multi-user MIMO transmission, based on the selected first pre-coding matrix, the selected second pre-coding matrix, and the estimation result of the channel state, and
the feedback information generation unit generates first pre-coding matrix information indicating the selected first pre-coding matrix, second pre-coding matrix information indicating the selected second pre-coding matrix, and channel quality information indicating the calculated channel quality during the multi-user MIMO transmission, as feedback information.

10: The terminal device according to claim 8,
wherein when the first feedback timing and the second feedback timing match each other,
the pre-coding matrix selection unit selects a first pre-coding matrix from the first codebook and selects a second pre-coding matrix from the second codebook, respectively,
the channel quality calculation unit calculates a first channel quality during the multi-user MIMO transmission, based on the selected first pre-coding matrix and the estimation result of the channel state, and calculates a second channel quality during the multi-user MIMO transmission, based on the selected first pre-coding matrix, the selected second pre-coding matrix, and the estimation result of the channel state, and
the feedback information generation unit generates first pre-coding matrix information indicating the selected first pre-coding matrix, second pre-coding matrix information indicating the selected second pre-coding matrix, channel quality information indicating the first channel quality, and differential channel quality information indicating a differential value between the second channel quality and the first channel quality, as feedback information.

11: The terminal device according to claim 8,
wherein when the first feedback timing and the second feedback timing match each other, the terminal device performs a process relating to the first feedback timing.

12: A base station device that is provided with a plurality of antennas, and simultaneously transmits transmission data addressed to a plurality of terminal devices by performing pre-coding and spatial-multiplexing on the transmission data, the base station device comprising:
a feedback information obtaining unit that obtains either one or both of first pre-coding matrix information indicating a first pre-coding matrix which is selected from a first codebook including at least one pre-coding matrix candidate, and second pre-coding matrix information indicating a second pre-coding matrix which is selected from a second codebook including at least one pre-coding matrix candidate, of which notifications are sent from the plurality of terminal devices, obtains either one or both of channel quality information indicating a channel quality during multi-user MIMO transmission, and differential channel quality information based on a difference value from a channel quality indicated by the channel quality information, and calculates a desired pre-coding matrix which is selected by each of the plurality of terminal devices and a channel quality during the multi-user MIMO transmission; and
a pre-coding matrix calculation unit that calculates a pre-coding matrix which is used for pre-coding of transmission data addressed to the plurality of terminal devices, based on the calculated desired pre-coding matrix for each terminal device and the calculated channel quality during the multi-user MIMO transmission, and determines a modulation scheme and a coding rate for the transmission data addressed to the plurality of terminal devices.

13: The base station device according to claim 12,
wherein when the differential channel quality information is obtained from the terminal device, the feedback information obtaining unit calculates a result obtained by adding a channel quality indicated by channel quality information of which notification is most recently sent from the terminal device to a differential value from a channel quality indicated by the differential channel quality information, as channel quality during the multi-user MIMO transmission of the terminal device.

14: The base station device according to claim 12,
wherein when notifications of the channel quality information and the differential channel quality information are sent at the same timing from a terminal device, the feedback information obtaining unit calculates a result obtained by adding a channel quality indicated by the channel quality information to a differential value from a channel quality indicated by the differential channel quality information, as channel quality during the multi-user MIMO transmission of the terminal device.

15-17. (canceled)
